(19) United States
(12) Patent Application Publication
(10) Pub. No.: US 2024/0417598 A1
(43) Pub. Date: Dec. 19, 2024

(54) SELF-ADHERING SEALING ELEMENT

(71) Applicant: SIKA TECHNOLOGY AG, Baar (CH)

(72) Inventors: Markus HAUFE, Zürich (CH); Cyrill GUT, Wädenswil (CH); Ramon BUCHER, Kerns (CH); Josef LUSSI, Kerns (CH); Helena WALLIMANN, Alpnach (CH); Simon SCHOENBRODT, Sarnen (CH)

(73) Assignee: SIKA TECHNOLOGY AG, Baar (CH)

(21) Appl. No.: 18/701,393

(22) PCT Filed: Nov. 14, 2022
(86) PCT No.: PCT/EP2022/081751

§ 371 Date: Apr. 15, 2024

(30) Foreign Application Priority Data
Nov. 22, 2021 (EP) 2109675.4

(51) Int. Cl. C09J 7/24; C09J 123/22; C09J 133/08

(52) U.S. Cl. CPC C09J 7/241; C09J 123/22; C09J 133/08; C09J 2301/16; C09J 2301/204; C09J 2301/302; C09J 2301/414

(57) ABSTRACT

A sealing element includes a carrier layer having a first and a second major surface, a pressure sensitive adhesive layer having a thickness of at least 100 μm, and optionally a release liner covering at least a portion of an outer major surface of the pressure sensitive adhesive layer facing away from the carrier layer, wherein the carrier layer includes at least one elastomer E and/or at least one thermoplastic vulcanizate TPV and has a thickness of at least 0.2 mm.

### TECHNICAL FIELD

The invention relates to the field of sealing of above ground building constructions by using water impermeable sealing elements. In particular, the invention relates to self-adhering waterproofing tapes, which are used for sealing of structures against penetration of water, moisture, or harmful gases.

### BACKGROUND OF THE INVENTION

In the field of construction, polymeric sealing elements that are often referred to as membranes, panels, sheets, or liners are used to protect underground and above ground constructions, such as base slabs, walls, floors, basements, tunnels, wet rooms, building facades, flat and low-sloped roofs, landfills, water-retaining structures, ponds, and dikes against penetration of water, moisture, volatile organic compounds, or harmful gases. The membranes are typically delivered to a construction site in form of rolls, transferred to the place of installation, unrolled, and adhered or mechanically fastened to the substrate to be sealed.

Waterproofing membranes are applied, for example, to prevent ingress of water through cracks that develop in the concrete structure due to building settlement, load deflection or concrete shrinkage. They are also used in heavy loaded commercial and residential wet rooms, shower rooms or therapy rooms in hospitals, and on balconies, terraces and in swimming pools to protect the structures against penetration of water. Roofing membranes are used for sealing of flat and low-sloped roof structures to prevent leaks and to take water off the roof.

Gas barrier membranes are used for restricting the ingress of harmful gases, such as radon, methane, and carbon dioxide, into buildings from landfill and naturally occurring sources. These types of membranes are typically used in ground floors above and below concrete slabs that are not subjected to hydrostatic pressure. Vapor barriers and retarders are used to control the movement of water through a building structure by vapor diffusion. Vapor retarding membranes are provided with different water vapor permeance properties or permeability and they are commonly provided as coatings or multilayer composites composed of several thin films or as structural vapor retarders. Geomembranes are used in contact with soil or rock to act as a barrier to passage of water and water-borne contaminants.

Sealing elements are also provided in form of single- or double-sided adhesive tapes, which are used, for example, for sealing of construction gaps in building facades or joints formed between adjacent membranes, for repairing of leaking roof structures, or for connection of building segments, such as wall structures and window components. Adhesive tapes used in the construction industry typically consist of a polymeric support layer, which has been coated on one or both sides with a pressure sensitive adhesive (PSA), which is usually covered with a release liner to protect the adhesive from moisture, fouling, and other environmental factors.

Commonly used materials for membranes and tapes include plastics, particularly thermoplastics such as plasticized polyvinylchloride (p-PVC), thermoplastic olefins (TPE-O, TPO), and elastomers such as ethylene-propylene diene monomer (EPDM) rubber. Bituminous materials are also used since they provide good resistance against environmental factors combined with relatively low costs compared to thermoplastic polymer materials. Bitumen compositions are typically modified with synthetic polymers to improve resistance to UV-radiation, toughness, and flexibility at low temperatures. The substrate on which the membrane or tape is adhered may be comprised of variety of materials depending on the installation site. The substrate may, for example, be a concrete, fiber concrete, metal, glass, plastic, or a plywood substrate, or it may include an insulation board or cover board and/or an existing roofing or waterproofing membrane.

Adhesive tapes used in the field of construction must fulfil various requirements related to flexibility, elongation, elastic recovery, UV-stability, concentration of monomeric plasticizers, and strength of adhesion to various substrates. Commercially available adhesive tapes are typically designed for a single specific purpose, such as for sealing of joints formed between adjacent membranes and are, therefore, less suitable for any other application, such as for repairing of damaged roofing membranes. There is thus a need for “universal adhesive tape” for use in the field of construction industry, which adhesive tape can cope with the multitude of application related requirements.

### SUMMARY OF THE INVENTION

The object of the present invention is to provide a multi-purpose self-adhering sealing element that is suitable for use, for example, in sealing of construction gaps in building facades, sealing of joints between adjacent membranes, connecting building segments, or in repairing of leaking roof structures.

The subject of the present invention is a sealing element as defined in claim 1.

It was surprisingly found out that a sealing element comprising a carrier layer having a thickness of at least 0.2 mm and a pressure sensitive adhesive layer having a thickness of at least 100 μm, wherein the carrier layer comprises a polymer component comprising at least one elastomer and/or thermoplastic vulcanizate, is especially suitable for use as a multi-purpose adhesive tape.

One of the advantages of the sealing element of the present invention is that it is suitable for use as a multi-purpose adhesive tape, i.e., the sealing element is suitable for use in various applications without any modifications of the basic structure of the element, which enables significant costs savings in production of the sealing element. Furthermore, bonding of the sealing element to a substrate can be conducted using the factory applied adhesive layer(s), which simplifies the installation process at the construction site.

Other aspects of the present invention are presented in other independent claims. Preferred aspects of the invention are presented in the dependent claims.

### BRIEF DESCRIPTION OF THE DRAWINGS

FIG. 1 shows a cross-section of a sealing element (1) comprising a carrier layer (2) having a first and a second major surface and a pressure sensitive adhesive layer (3) covering the second major surface of the carrier layer (2), and a release liner (4) covering the outer major surface of the pressure sensitive adhesive layer (3) facing away from the carrier layer (2).

FIG. 2 shows a cross-section of a sealing device (1) comprising a carrier layer (2) having a first and a second major surface, a pressure sensitive adhesive layer (3) covering the second major surface of the carrier layer (2), a further pressure sensitive adhesive layer (3′) covering the first major surface of the carrier layer (2), a release liner (4) covering the outer major surface of the pressure sensitive adhesive layer (3) facing away from the carrier layer (2) and a further release liner (4′) covering the outer major surface of the further pressure sensitive adhesive layer (3′) facing away from the carrier layer (2).

FIG. 3 shows a cross-section of a sealing element (1) comprising a carrier layer (2) having a first and a second major surface, an adhesive sealant layer (5) covering the second major surface of the carrier layer (2), a pressure sensitive adhesive layer (3) covering the second major surface of the adhesive sealant layer (5), and a release liner (4) covering the outer major surface of the pressure sensitive adhesive layer (3) facing away from the carrier layer (2).

FIG. 4 shows a cross-section of a sealing element (1) comprising a carrier layer (2) having a first and a second major surface, an adhesive sealant layer (5) covering the second major surface of the carrier layer (2), a pressure sensitive adhesive layer (3) covering a portion the second major surface of the adhesive sealant layer (5), and a release liner (4) covering the outer major surface of the pressure sensitive adhesive layer (3) facing away from the carrier layer (2), wherein the pressure sensitive adhesive layer (3) is in form of a discontinuous adhesive layer, which is partially embedded into the adhesive sealant layer (5).

FIG. 5 shows a cross-section of a sealing device (1) comprising a carrier layer (2) having a first and a second major surface, an adhesive sealant layer (5) covering the second major surface of the carrier layer (2), a pressure sensitive adhesive layer (3) covering the second major surface of the adhesive sealant layer (5), a release liner (4) covering the outer major surface of the pressure sensitive adhesive layer (3) facing away from the carrier layer (2), a further adhesive sealant layer (5′) covering the first major surface of the carrier layer (2), a further pressure sensitive adhesive layer (3′) covering the first major surface of the further adhesive sealant layer (5′), and a further release liner (4′) covering the outer major surface of the further pressure sensitive adhesive layer (3′) facing away from the carrier layer (2).

FIG. 6 shows a cross-section of a sealing device (1) comprising a carrier layer (2) having a first and a second major surface, an adhesive sealant layer (5) covering the second major surface of the carrier layer (2), a pressure sensitive adhesive layer (3) covering a portion of the second major surface of the adhesive sealant layer (5), a release liner (4) covering the outer major surface of the pressure sensitive adhesive layer (3) facing away from the carrier layer (2), a further adhesive sealant layer (5′) covering the first major surface of the carrier layer (2), a further pressure sensitive adhesive layer (3′) covering a portion of the first major surface of the further adhesive sealant layer (5′), and a further release liner (4′) covering the outer major surface of the further pressure sensitive adhesive layer (3′) facing away from the carrier layer (2), wherein the pressure sensitive adhesive layer (3) is in form of a discontinuous adhesive layer, which is partially embedded into the adhesive sealant layer (5) and wherein the further pressure sensitive adhesive layer (3′) is in form of a discontinuous adhesive layer, which is partially embedded into the further adhesive sealant layer (5′).

FIG. 7 shows a perspective view of a sealing element (1), wherein the pressure sensitive adhesive layer (3) has a pattern comprising a plurality of spaced-apart adhesive coated areas in form of adhesive stripes extending in the longitudinal direction (L) of the sealing element (1).

FIG. 8 shows a perspective view of a sealing element (1), wherein the pressure sensitive adhesive layer (3) has a pattern comprising a plurality of spaced-apart adhesive coated areas in form of adhesive stripes extending in the transverse direction of the sealing element (1).

FIG. 9 shows a perspective view of a sealing element (1) wherein the pressure sensitive adhesive layer (3) has a pattern comprising a plurality of spaced-apart adhesive coated areas in form of circular dots.

FIG. 10 shows a perspective view of a sealing element (1) wherein the pressure sensitive adhesive layer (3) has a pattern comprising a plurality of spaced-apart adhesive coated areas in form of rectangular dots.

FIG. 11 shows a perspective view of a sealing element (1) wherein the pressure sensitive adhesive layer (3) has a pattern comprising an adhesive coated area and a plurality of spaced-apart adhesive free areas having a rectangular shape.

FIG. 12 shows a perspective view of a sealing element (1) wherein the pressure sensitive adhesive layer (3) has a pattern comprising an adhesive coated area and a plurality of spaced-apart adhesive free areas having a circular shape.

FIG. 13 shows a cross-section of a sealed substrate comprising a substrate (6) and a sealing element (1) as shown in FIG. 1 without the release liner (4), wherein the second major surface of the carrier layer (2) is bonded to a surface of the substrate (6) via the pressure sensitive adhesive layer (3).

FIG. 14 shows a schematic presentation of an arrangement used for measuring the holding time of self-adhering sealing elements.

### DETAILED DESCRIPTION OF THE INVENTION

The subject of the present invention a sealing element (1) comprising:
i) A carrier layer (2) having a first and a second major surface,
ii) A pressure sensitive adhesive layer (3) having a thickness of at least 100 μm, and
iii) Optionally a release liner (4) covering at least a portion of an outer major surface of the pressure sensitive adhesive layer (3) facing away from the carrier layer (2),
wherein the carrier layer (2) comprises a polymer component comprising at least one elastomer E and/or at least one thermoplastic vulcanizate TPV and wherein the carrier layer (2) has a thickness of at least 0.2 mm.

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “polymer” refers to a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “elastomer” designates a polymer or a polymer blend, which is capable of recovering from large deformations, and which can be, or already is, modified to a state in which it is essentially insoluble (but can swell) in a boiling solvent, in particular xylene. Typical elastomers are capable of being elongated or deformed to at least 200% of their original dimension under an externally applied force, and will substantially resume the original dimensions, sustaining only small permanent set (typically no more than about 20%), after the external force is released. As used herein, the term “elastomer” may be used interchangeably with the term “rubber.”

The term “copolymer” refers to a polymer derived from more than one species of monomer (“structural unit”). The polymerization of monomers into copolymers is called copolymerization. Copolymers obtained by copolymerization of two monomer species are known as bipolymers and those obtained from three and four monomer species are called terpolymers and quaterpolymers, respectively.

“Comonomer content of a copolymer” refers to the total amount of comonomers in the copolymer given in wt.-% or mol-%. The comonomer content can be determined by IR spectroscopy or by quantitative nuclear-magnetic resonance (NMR) measurements.

The term “melting temperature” designates a temperature at which a material undergoes transition from the solid to the liquid state. The melting temperature (Tm) is preferably determined by differential scanning calorimetry (DSC) according to ISO 11357-3 standard using a heating rate of 2° C./min. The measurements can be performed with a Mettler Toledo DSC 3+ device and the Tm values can be determined from the measured DSC-curve with the help of the DSC-software. In case the measured DSC-curve shows several peak temperatures, the first peak temperature coming from the lower temperature side in the thermogram is taken as the melting temperature (Tm).

The term “glass transition temperature” (Tg) designates the temperature above which temperature a polymer component becomes soft and pliable, and below which it becomes hard and glassy. The glass transition temperature is preferably determined by dynamical mechanical analysis (DMA) as the peak of the measured loss modulus (G″) curve using an applied frequency of 1 Hz and a strain level of 0.1%.

The term “molecular weight” designates the molar mass (g/mol) of a molecule or a part of a molecule, also referred to as “moiety”. The term “average molecular weight” refers to weight average (M_{w}) or number average (Mₙ) molecular weight of an oligomeric or polymeric mixture of molecules or moieties. The molecular weight may be determined by conventional methods, preferably by gel permeation-chromatography (GPC) using polystyrene as standard, styrene-divinylbenzene gel with porosity of 100 Angstrom, 1000 Angstrom and 10000 Angstrom as the column and, depending on the molecule, tetrahydrofurane as a solvent, at 35° C., or 1,2,4-trichlorobenzene as a solvent, at 160° C.

The term “crosslinked” refers to a polymer matrix, in which the polymer chains are inter-connected by a plurality of covalent bonds that are stable mechanically and thermally. Other possible forms of crosslinked polymers such as physically crosslinked polymers are not regarded as “crosslinked” in the context of the present disclosure. The term “vulcanized” may be used interchangeably with the term “crosslinked”.

The term “crosslinking degree” refers to a proportion of the component, which is insoluble in boiling xylene. The percentage of insoluble proportion can be determined by refluxing a test specimen in boiling xylene, weighting the dried residue, and making suitable corrections for other soluble and insoluble components present in the tested composition. Preferably, the crosslinking degree is measured by using a method as defined in ISO 10147:2011 standard.

The “amount or content of at least one component X” in a composition, for example “the amount of the at least one elastomer E” refers to the sum of the individual amounts of all elastomers E contained in the composition. Furthermore, in case the composition comprises 20 wt.-% of at least one elastomer E, the sum of the amounts of all elastomers E contained in the composition equals 20 wt.-%.

The term “room temperature” designates a temperature of 23° C.

The sealing element of the present invention comprises a carrier layer comprising a polymer component comprising at least one elastomer E and/or at least one thermoplastic vulcanizate TPV.

The term “layer” refers in the present disclosure to a sheet-like element having first and second major surfaces, i.e. top and bottom surfaces, a width defined between the longitudinally extending edges, and a thickness defined between the first and second major surfaces. Preferably, a layer has a length and width at least 5 times, more preferably at least 15 times, even more preferably at least 25 times greater than the thickness of the layer

Preferably, the polymer component comprises at least 1.5 wt.-%, more preferably at least 2.5 wt.-%, even more preferably at least 5 wt.-%, still more preferably at least 7.5 wt.-%, of the at least one elastomer E and/or the at least one thermoplastic vulcanizate TPV, based on the total weight of the polymer component.

According to one or more embodiments, the polymer component comprises at least 65 wt.-%, preferably at least 75 wt.-%, more preferably at least 85 wt.-%, even more preferably at least 90 wt.-%, of the at least one elastomer E or the at least one thermoplastic vulcanizate TPV, based on the total weight of the polymer component.

According to one or more preferred embodiments, the polymer component comprises 1.5-55 wt.-%, preferably 2.5-50 wt.-%, more preferably 5-45 wt.-%, even more preferably 7.5-40 wt.-%, still more preferably 7.5-35 wt.-%, of the at least one elastomer E or the at least one thermoplastic vulcanizate TPV, based on the total weight of the polymer component.

According to one or more embodiments, the polymer component comprises, in addition to the at least one elastomer E and/or the at least one thermoplastic vulcanizate TPV, at least one propylene copolymer PC, preferably having a propylene content of at least 65 wt.-%, preferably at least 75 wt.-%, based on the weight of the propylene copolymer.

According to one or more embodiments, the polymer component comprises at least 2.5 wt.-%, more preferably at least 5 wt.-%, even more preferably at least 10 wt.-%, still more preferably at least 15 wt.-%, of the at least one propylene copolymer PC, based on the total weight of the polymer component.

According to one or more preferred embodiments, the polymer component comprises 5-85 wt.-%, preferably 15-75 wt.-%, more preferably 20-70 wt.-%, even more preferably 25-70 wt.-%, still more preferably 30-65 wt.-%, of the at least one propylene copolymer PC, based on the total weight of the polymer component.

Carrier layers according to the above defined embodiments have been found to provide superior performance in terms of flexibility, elongation, and elastic recovery compared to State-of-the-Art waterproofing and roofing tapes.

Preferably, the at least one elastomer E is selected from the group consisting of butyl rubber, halogenated butyl rubber, ethylene-propylene diene monomer rubber, natural rubber, chloroprene rubber, synthetic 1,4-cis-polyisoprene, polybutadiene, ethylene-propylene rubber, styrene-butadiene copolymer, isoprene-butadiene copolymer, styrene-isoprene-butadiene rubber, methyl methacrylate-butadiene copolymer, methyl methacrylate-isoprene copolymer, acrylonitrile-isoprene copolymer, and acrylonitrile-butadiene copolymer.

Preferred rubbers for use as the at least one elastomer E have a relatively low degree of unsaturation. The term “degree of unsaturation” refers in the present disclosure to the ratio of the number of unsaturated carbon-to-carbon bonds to the number of atoms in the linear chain of the average theoretical linear elastomer molecule. The low degree of unsaturation is essential in applications, where carrier layer must be able to withstand permanent exposure to various environmental factors, particularly UV-radiation.

According to one or more embodiments, the at least one elastomer E has a mole percent unsaturation of not more than 15, preferably not more than 10, more preferably not more than 5, even more preferably not more than 2.5.

According to one or more embodiments, the at least one elastomer E has a Mooney Viscosity (ML 1+8 at 125° C.) of not more than 150 MU, preferably not more than 100 MU, more preferably not more than 85 MU, even more preferably not more than 70 MU, still more preferably not more than 55 MU, such as in the range of 10-125 MU, preferably 15-100 MU, more preferably 15-75 MU, even more preferably 20-65 MU.

The term “Mooney viscosity” refers in the present disclosure to the viscosity measure of rubbers. It is defined as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in ASTM D1646-19a standard.

It may further be preferred that the at least one elastomer E has a crosslinking degree determined by using the method as defined in ISO 10147:2011 standard of not more than wt.-%, more preferably not more than 5 wt.-%, even more preferably not more than 2.5 wt.-%, still more preferably not more than 1.5 wt.-%.

According to one or more embodiments, the at least one elastomer E comprises at least one butyl rubber E1 and/or at least one ethylene propylene diene monomer (EPDM) rubber E2.

Generally, the expression “the at least one component X comprises at least one component XN”, such as “the at least one elastomer E comprises at least one butyl rubber E1” is understood to mean in the context of the present disclosure that the polymer component comprises one or more butyl rubbers E1 as representatives of the at least one elastomer E.

The term “butyl rubber” designates in the present disclosure a polymer derived from a monomer mixture containing a major portion of a C₄ to C₇ monoolefin monomer, preferably an isoolefin monomer and a minor portion, such as not more than 30 wt.-%, of a C₄ to C₁₄ multiolefin monomer, preferably a conjugated diolefin.

The preferred C₄ to C₇ monoolefin monomer may be selected from the group consisting of isobutylene, 2-methyl-1-butene, 3-methyl-1-butene, 2-methyl-2-butene, 4-methyl-1-pentene, and mixtures thereof.

The preferred C₄ to C₁₄ multiolefin comprises a C₄ to C₁₀ conjugated diolefin. The preferred C₄ to C₁₀ conjugated diolefin may be selected from the group comprising isoprene, butadiene, 2,4-dimethylbutadiene, piperyline, 3-methyl-1,3-pentadiene, 2,4-hexadiene, 2-neopentyl-1,3-butadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, 1-vinyl-cyclohexadiene and mixtures thereof.

Preferably, the at least one butyl rubber E1 is derived from a monomer mixture containing from about 80 wt.-% to about 99 wt.-% of a C₄ to C₇ monoolefin monomer and from about 1.0 wt.-% to about 20 wt.-% of a C₄ to C₁₄ multiolefin monomer. More preferably, the monomer mixture contains from about 85 wt.-% to about 99 wt.-% of a C₄ to C₇ monoolefin monomer and from about 1.0 wt.-% to about 10 wt.-% of a C₄ to C₁₄ multiolefin monomer. Most preferably, the monomer mixture contains from about 95 wt.-% to about 99 wt.-% of a C₄ to C₇ monoolefin monomer and from about 1.0 wt.-% to about 5.0 wt.-% of a C₄ to C₁₄ multiolefin monomer.

The most preferred at least one butyl rubber E1 is derived from a monomer mixture comprising from about 97 wt.-% to about 99.5 wt.-% of isobutylene and from about 0.5 wt.-% to about 3 wt.-% of isoprene.

It is furthermore possible to include an optional third monomer to produce a butyl terpolymer. For example, it is possible to include a styrenic monomer in the monomer mixture, preferably in an amount up to about 15 wt.-% of the monomer mixture. The preferred styrenic monomer may be selected from the group comprising p-methylstyrene, styrene, α-methylstyrene, p-chlorostyrene, p-methoxystyrene, indene, indene derivatives and mixtures thereof. The most preferred styrenic monomer may be selected from the group comprising styrene, p-methylstyrene and mixtures thereof. Other suitable copolymerizable termonomers will be apparent to those of skilled in the art.

According to one or more embodiments, the at least one butyl rubber E1 is a halogenated butyl rubber. The term “halogenated rubber” refers in the present disclosure to a rubber having a halogen content of at least 0.1 mol.-%, wherein the halogen is preferably selected from the group consisting of bromine, chlorine and iodine. Preferred halogenated butyl rubbers to be used as the at least one butyl rubber E1 have a halogen content of 0.1-10 wt.-%, preferably 0.5-8 wt.-%, more preferably 0.5-5.0 wt.-%, based on the weight of the halogenated butyl rubber.

According to one or more embodiments, the at least one butyl rubber E1 is a bromobutyl rubber or a chlorobutyl rubber, preferably having a halogen content in the range of 0.1-10 wt.-%, more preferably 0.5-8 wt.-%, even more preferably 0.5-5.0 wt.-%, based on the weight of the halogenated butyl rubber.

The term “EPDM rubber” refers in the present disclosure to terpolymer of ethylene, propylene, and a non-conjugated diene. Non-limiting examples of suitable non-conjugated dienes to be used in EPDM rubber include, for example, 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,4-cyclohexadiene; tetrahydroindene; methyltetrahydroindene; dicyclopentadiene; 5-isopropylidene-2-norbornene; and 5-vinyl-norbornene.

Suitable rubbers for use as the at least one EPDM rubber E2 have an ethylene content of at least 20 wt.-%, preferably at least 25 wt.-%, based on the weight of the rubber and a non-conjugated diene content of not more than 20 wt.-%, preferably not more than 15 wt.-%, based on the weight of the rubber, with the remaining content being essentially composed of polypropylene.

According to one or more embodiments, the at least one EPDM rubber E2 has
an ethylene content of 25-85 wt.-%, preferably 35-80 wt.-%, more preferably 45-80 wt.-%, even more preferably 55-75 wt.-%, based on the weight of the EPDM rubber and/or
a non-conjugated diene content of 1-20 wt.-%, preferably 1-15 wt.-%, more preferably 2-15 wt.-%, even more preferably 2-10 wt.-%, based on the weight of the EPDM rubber and/or
a Mooney Viscosity (ML 1+4 at 125° C.) of not more than 125 MU, preferably not more than 100 MU, more preferably not more than 75 MU, even more preferably not more than 65 MU, still more preferably not more than 55 MU, such as in the range of 5-100 MU, preferably 10-85 MU, more preferably 15-75 MU, even more preferably 20-65 MU.

Suitable EPMD rubbers are commercially available, for example, under the trade name of Nordel® (from Dow Chemical Company), under the trade name of Buna EP® (from Lanxess), and under the trade name of Vistalon® (from Exxon Mobil).

According to one or more embodiments, the at least one elastomer E comprises at least 50 wt.-%, preferably at least 65 wt.-%, more preferably at least 75 wt.-%, even more preferably at least 85 wt.-%, still more preferably at least 90 wt.-%, of the at least one butyl rubber E1, based on the total weight of the at least one elastomer E.

According to one or more embodiments, the at least one elastomer E comprises the at least one butyl rubber E1 and the at least one EPDM rubber E2, wherein the ratio of the weight of the at least one butyl rubber E1 to the weight of the at least one EPDM rubber E2 in the polymer component is in the range of 5:1 to 1:5, preferably 3:1 to 1:3, more preferably 2:1 to 1:2, even more preferably 1.5:1 to 1:1.5.

According to one or more embodiments, the at least one elastomer E is composed of the at least one butyl rubber E1.

Suitable methods for producing carrier layers comprising a polymer component, wherein the at least one elastomer E composed of the at least one butyl rubber E1 are disclosed in published patent application EP 3662014 A1.

Thermoplastic vulcanizates are thermoplastic elastomers (TPE) containing a dynamically vulcanized (crosslinked) elastomer component with a plastic component.

Preferably, the at least one thermoplastic vulcanizate TPV comprises a blend of a thermoplastic resin and particles of a at least partially vulcanized rubber dispersed throughout a matrix of the thermoplastic resin. The term “matrix” refers here to a continuous phase of the thermoplastic resin.

Suitable rubbers for use in the blend of the at least one thermoplastic vulcanizate TPV include, for example, butyl rubber, halogenated butyl rubber, ethylene-propylene diene rubber, natural rubber, chloroprene rubber, synthetic 1,4-cis-polyisoprene, polybutadiene, ethylene-propylene rubber, styrene-butadiene copolymer, isoprene-butadiene copolymer, styrene-isoprene-butadiene rubber, methyl methacrylate-butadiene copolymer, methyl methacrylate-isoprene copolymer, acrylonitrile-isoprene copolymer, and acrylonitrile-butadiene copolymer.

According to one or more embodiments, the rubber is selected from the group consisting of butyl rubber, halogenated butyl rubber, ethylene-propylene diene rubber, natural rubber, synthetic 1,4-cis-polyisoprene, polybutadiene, and ethylene-propylene rubber.

Suitable thermoplastic resins for use in the blend of the at least one thermoplastic vulcanizate TPV include, for example, polyolefins, such as polyethylene, ethylene copolymers, polypropylene, and propylene copolymers. According to one or more embodiments, the thermoplastic resin comprises a propylene copolymer, preferably a random propylene copolymer, preferably having a melting temperature determined by DSC according to 11357-3:2018 standard using a heating rate of 2° C./min of not more than 135° C., more preferably not more than 115° C., even more preferably not more than 105° C.

According to one or more embodiments, the blend of the at least one thermoplastic vulcanizate TPV comprises 15-75 parts by weight of the thermoplastic resin and 25-85 parts by weight of the at least partially vulcanized rubber per 100 parts total weight of the thermoplastic resin and the at least partially vulcanized rubber.

According to one or more embodiments, the blend of the at least one thermoplastic vulcanizate TPV further comprises 10-300 parts by weight, preferably 50-250 parts by weight, of an additive oil per 100 parts by weight of the at least partially vulcanized rubber.

Preferred additive oils for use in the blend of the at least one thermoplastic vulcanizate TPV include process oils, such as mineral oils, synthetic oils, and vegetable oils, and liquid polyolefin resins as well as organic esters and synthetic plasticizers.

The term “mineral oil” refers in the present disclosure to hydrocarbon liquids of lubricating viscosity (i.e., a kinematic viscosity at 100° C. of 1 cSt or more) derived from petroleum crude oil and subjected to one or more refining and/or hydroprocessing steps, such as fractionation, hydrocracking, dewaxing, isomerization, and hydrofinishing, to purify and chemically modify the components to achieve a final set of properties. In other words, the term “mineral” refers in the present disclosure to refined mineral oils, which can be also characterized as Group I-III base oils according the classification of the American Petroleum Institute (API).

Suitable mineral oils to be used as the additive oil include paraffinic, naphthenic, and aromatic mineral oils. Particularly suitable mineral oils include paraffinic and naphtenic oils containing relatively low amounts of aromatic moieties, such as not more than 25 wt.-%, preferably not more than 15 wt.-%, based on the total weight of the mineral oil.

The term “synthetic oil” refers in the present disclosure to full synthetic (polyalphaolefin) oils, which are also known as Group IV base oils according to the classification of the American Petroleum Institute (API). Suitable synthetic oils are produced from liquid polyalphaolefins (PAOs) obtained by polymerizing α-olefins in the presence of a polymerization catalyst, such as a Friedel-Crafts catalyst. In general, liquid PAOs are high purity hydrocarbons with a paraffinic structure and high degree of side-chain branching.

Particularly suitable synthetic oils include those obtained from so-called Gas-To-Liquid processes.

According to one or more embodiments, the at least partially vulcanized rubber of the at least one thermoplastic vulcanizate TPV has a crosslinking degree determined by using the method as defined in ISO 10147:2011 standard of at least 50 wt.-%, preferably at least 75 wt.-%, more preferably at least 80 wt.-%, even more preferably at least 90 wt.-%.

Suitable thermoplastic vulcanizates for use as the at least one thermoplastic vulcanizate TPV are commercially available, for example, under the trade name of Milastomer® (from Mitsui Chemicals) and under the trade name of Santoprene® (from Exxon Mobil).

Suitable copolymers for use as the at least one propylene copolymer PC include random and block copolymers of propylene with ethylene and/or with one or more C₄-C₂₀ α-olefin monomers, particularly one or more of 1-butene, 1-pentene, 1-hexene, 1-heptene, 1-octene, 1-decene, 1-dodecene, and 1-hexadodecene, preferably comprising at least 55 wt.-%, more preferably at least 65 wt.-%, of propylene-derived units, based on the weight of the copolymer.

According to one or more embodiments, the at least one propylene copolymer PC has:
a flexural modulus at 23° C. determined according to ISO 178:2019 standard of not more than 100 MPa, preferably not more than 75 MPa, more preferably not more than 65 MPa, even more preferably not more than 50 MPa and/or
a melt flow rate (230° C./2.16 kg) determined according to ISO 1133 standard of not more than 50 g/10 min, preferably not more than 35 g/10 min, more preferably not more than 25 g/10 min, even more preferably not more than 20 g/10 min and/or
a density at 23° C. determined according to ASTM D-792 standard of 0.850-0.900 g/cm3, preferably 0.855-0.890 g/cm3 and/or
a softening point measured by a Ring and Ball method according to DIN EN 1238 standard of not more than 95° C., preferably not more than 85° C., more preferably not more than 75° C.

According to one or more embodiments, the at least one propylene copolymer PC is a propylene-ethylene copolymer, preferably a propylene-ethylene random copolymer, preferably having an ethylene content of 5-20 wt.-%, more preferably 9-18 wt.-%, even more preferably 12-18 wt.-%, even more preferably 12-16 wt.-%, based on the weight of the propylene copolymer and preferably having a flexural modulus at 23° C. determined according to ISO 178:2019 standard of not more than 100 MPa, more preferably not more than 75 MPa, even more preferably not more than 50 MPa and/or a softening point measured by a Ring and Ball method according to DIN EN 1238 standard of not more than 95° C., preferably not more than 85° C., more preferably not more than 75° C.

Especially suitable propylene-ethylene copolymers include the propylene-ethylene copolymers, which are commonly characterized as “propylene-based elastomers”. These types of propylene-ethylene copolymers are commercially available, for example, under the trade name of Versify® (from Dow Chemicals) and under the trade name of Vistamaxx® (from Exxon Mobil).

According to a first preferred embodiment, the polymer component comprises:
2.5-50 wt.-%, preferably 5-45 wt.-%, more preferably 7.5-40 wt.-%, even more preferably 10-40 wt.-%, still more preferably 10-35 wt.-%, of the at least one elastomer E and
5-85 wt.-%, preferably 15-75 wt.-%, more preferably 20-70 wt.-%, even more preferably 25-70 wt.-%, still more preferably 30-65 wt.-%, of the at least one propylene copolymer PC, all proportions being based on the total weight of the polymer component.

According to a second preferred embodiment, the polymer component comprises:
1.5-45 wt.-%, preferably 2.5-40 wt.-%, more preferably 5-35 wt.-%, even more preferably 7.5-35 wt.-%, still more preferably 10-30 wt.-%, of the at least one thermoplastic vulcanizate TPV and
5-85 wt.-%, preferably 15-75 wt.-%, more preferably 20-70 wt.-%, even more preferably 25-70 wt.-%, still more preferably 30-65 wt.-%, of the at least one propylene copolymer PC, all proportions being based on the total weight of the polymer component.

The polymer component may further comprise, in addition to the at least one elastomer E and/or the at least one thermoplastic vulcanizate TPV and the at least one propylene copolymer PC, at least one thermoplastic polyolefin elastomer TPO.

The term “thermoplastic polyolefin elastomer (TPO, TPE-O)” refers to specific type of thermoplastic elastomers (TPE), which are provided as physical or reactor blends of olefinic constituents. TPOs are heterophasic polymer systems comprising a high crystallinity base polyolefin and a low-crystallinity or amorphous polyolefin modifier. The heterophasic phase morphology consists of a matrix phase composed primarily of the base polyolefin and a dispersed phase composed primarily of the polyolefin modifier. Commercially available TPOs include reactor blends of the base polyolefin and the polyolefin modifier, also known as “in-situ TPOs” or “reactor TPOs or “impact copolymers (ICP)”, as well as physical blends of the aforementioned components. In case of a reactor-blend type of TPO, the components are typically produced in a sequential polymerization process, wherein the components of the matrix phase are produced in a first reactor and transferred to a second reactor, where the components of the dispersed phase are produced and incorporated as domains in the matrix phase. A physical-blend type of TPO is produced by melt-mixing the base polyolefin with the polyolefin modifier each of which was separately formed prior to blending of the components.

Reactor-blend type TPOs comprising polypropylene homopolymer as the base polymer are often referred to as “heterophasic propylene copolymers (HECO)” whereas reactor-blend type TPOs comprising polypropylene random copolymer as the base polymer are often referred to as “heterophasic propylene random copolymers (RAHECO)”. The term “heterophasic propylene copolymer” encompasses in the present disclosure both the HECO and RAHECO types of heterophasic propylene copolymers.

Depending on the amount of the polyolefin modifier, the commercially available heterophasic propylene copolymers are typically characterized as “impact copolymers” (ICP) or as “reactor-TPOs” or as “soft-TPOs”. The main difference between these types of TPOs is that the amount of the polyolefin modifier is typically lower in ICPs than in reactor-TPOs and soft-TPOs, such as not more than 40 wt.-%, particularly not more than 35 wt.-%. Consequently, typical ICPs tend to have a lower xylene cold soluble (XCS) content determined according to ISO 16152 2005 standard as well as higher flexural modulus determined according to ISO 178:2019 standard compared to reactor-TPOs and soft-TPOs.

According to one or more embodiments, the at least one thermoplastic polyolefin elastomer TPO has:
a flexural modulus at 23° C. determined according to ISO 178:2019 standard of not more than 1000 MPa, preferably not more than 750 MPa, more preferably not more than 500 MPa, even more preferably not more than 350 MPa, still more preferably not more than 150 MPa, most preferably not more than 100 MPa and/or
a melting temperature determined by DSC according to ISO 11357 standard using a heating rate of 2° C./min of at least 100° C., preferably at least 110° C., more preferably at least 115° C., even more preferably at least 120° C. and/or
a melt flow rate (230° C./2.16 kg) determined according to ISO 1133 standard of not more than 50 g/10 min, preferably not more than 35 g/10 min, more preferably not more than 30 g/10 min, even more preferably not more than 25 g/10 min and/or
a xylene cold soluble content determined according to ISO 16152-2005 standard of at least 10 wt.-%, preferably at least 25 wt.-%, more preferably at least 35 wt.-%, even more preferably at least 45 wt.-%, still more preferably at least 55 wt.-%, such as in the range of
95 wt.-%, preferably 25-90 wt.-%, more preferably 35-85 wt.-%, even more preferably 45-80 wt.-%, still more preferably 50-70 wt.-%.

According to one or more embodiments, the at least one thermoplastic polyolefin elastomer TPO is a heterophasic propylene copolymer.

According to one or more embodiments, the at least one thermoplastic polyolefin elastomer TPO is a heterophasic propylene copolymer comprising:
A) at least one polypropylene having a melting temperature (Tm) of 100° C. or more, preferably a propylene homopolymer and/or a random copolymer of propylene having a comonomer content of less than 10 wt.-%, preferably less than 5 wt.-%, based on the weight of the copolymer and
B) at least one polyolefin having a glass transition temperature (Tg) of −20° C. or less, preferably an ethylene copolymer having a comonomer content of at least 5 wt.-%, preferably at least 10 wt.-%, based on the weight of the copolymer, preferably having a glass transition temperature (Tg) of −25° C. or less, more preferably −35° C. or less, preferably an ethylene-propylene rubber (EPR),
wherein the heterophasic propylene copolymer comprises a matrix phase composed primarily of A) and a dispersed phase composed primarily of B).

According to one or more embodiments, the heterophasic propylene copolymer is a reactor blend of A) and B), wherein the reactor blend has preferably been obtained by using a sequential polymerization process, wherein constituents of the matrix phase are produced in a first reactor and transferred to a second reactor where constituents of the dispersed phase are produced and incorporated as domains into the matrix phase.

Particularly suitable heterophasic propylene copolymers for use as the at least one thermoplastic polyolefin elastomer TPO include, for example, “reactor TPOs” and “soft TPOs” produced with LyondellBasell's Catalloy process technology, which are available under the trade names of Adflex®, Adsyl®, Clyrell®, Hifax®, Hiflex®, and Softell®, such as Hifax® CA 10A, Hifax® CA 12A, and Hifax® CA 60 A, and Hifax® CA 212 A. Further suitable heterophasic propylene copolymers are commercially available under the trade name of Borsoft® (from Borealis Polymers), such as Borsoft® SD233 CF.

According to one or more embodiments, the polymer component comprises 0.5-45 wt.-%, preferably 1.5-40 wt.-%, more preferably 5-35 wt.-%, even more preferably 7.5-35 wt.-%, still more preferably 10-30 wt.-%, of the at least one thermoplastic polyolefin elastomer TPO, based on of the total weight of the polymer component.

Preferably, the carrier layer comprises at least 35 wt.-%, more preferably at least 45 wt.-%, even more preferably at least 50 wt.-%, still more preferably at least 55 wt.-%, of the polymer component, based on the total weight of the carrier layer.

According to one or more embodiments, the carrier layer comprises 50-99 wt.-%, more preferably 60-97.5 wt.-%, even more preferably 70-95 wt.-%, still more preferably 80-95 wt.-%, of the polymer component, based on the total weight of the carrier layer.

According to one or more further embodiments, the carrier layer comprises 45-95 wt.-%, more preferably 50-90 wt.-%, even more preferably 55-85 wt.-%, still more preferably 60-85 wt.-%, of the polymer component, based on the total weight of the carrier layer.

The carrier layer may comprise, in addition to the polymer component, further constituents, such as fillers, UV- and heat stabilizers, antioxidants, plasticizers, flame retardants, dyes, pigments, matting agents, antistatic agents, impact modifiers, biocides, and processing aids such as lubricants, slip agents, antiblock agents, and denest aids.

According to one or more embodiments, the carrier layer further comprises at least one flame retardant FR.

The at least one flame retardant FR is preferably selected from the group consisting of magnesium hydroxide, aluminum trihydroxide, antimony trioxide, ammonium polyphosphate, and melamine-, melamine resin-, melamine derivative-, melamine-formaldehyde-, silane-, siloxane-, and polystyrene-coated ammonium polyphosphates.

Other suitable flame retardants for use as the at least one flame retardant FR include, for example, 1,3,5-triazine compounds, such as melamine, melam, melem, melon, ammeline, ammelide, 2-ureidomelamine, acetoguanamine, benzoguanamine, diaminophenyltriazine, melamine salts and adducts, melamine cyanurate, melamine borate, melamine orthophosphate, melamine pyrophosphate, dimelamine pyrophosphate and melamine polyphosphate, oligomeric and polymeric 1,3,5-triazine compounds and polyphosphates of 1,3,5-triazine compounds, guanine, piperazine phosphate, piperazine polyphosphate, ethylene diamine phosphate, pentaerythritol, borophosphate, 1,3,5-trihydroxyethylisocyanurate, 1,3,5-triglycidylisocyanurate, triallylisocyanurate and derivatives of the aforementioned compounds.

Suitable flame retardants are commercially available, for example, under the trade names of Martinal® and Magnifin® (both from Albemarle) and under the trade names of Exolit® (from Clariant), Phos-Check® (from Phos-Check) and FR CROS® (from Budenheim).

According to one or more embodiments, the carrier layer comprises 1-40 wt.-%, preferably 5-35 wt.-%, more preferably 10-35 wt.-%, even more preferably 10-30 wt.-%, of the at least one flame retardant FR, based on the total weight of the carrier layer.

The carrier layer may further comprise at least one UV-stabilizer, preferably at least one hindered amine light stabilizer (HALS). These types of compounds are typically added to polymer blends to prevent light-induced polymer degradation. Such UV-stabilizers are needed especially in case the sealing element is used in outdoor applications, for example, for sealing of roof structures or for waterproofing of construction gaps in building facades.

According to one or more embodiments, the carrier layer comprises 0.05-10 wt.-%, preferably 0.1-5 wt.-%, more preferably 0.25-2.5 wt.-%, even more preferably 0.25-1.5 wt.-%, based on the total weight of the carrier layer, of at least one hindered amine light stabilizer (HALS).

Especially suitable hindered amine light stabilizer (HALS) to be used in the carrier layer include alkoxyamine hindered amine light stabilizers (NOR-HALS). Suitable commercially NOR-HALSs include, for example:
bis-(1-octyloxy-2,2,6,6-tetramethyl-4-piperidinyl) sebacate, commercially available, for example, as Tinuvin® NOR 123 (from BASF, CAS number 129757-67-1); derivatives of N-butyl-2,2,6,6-tetramethyl-4-piperidinamine, commercially available, for example, as Tinuvin® NOR 152 (from BASF); reaction products with 3-bromo-1-propene, n-butyl-1-butanamine and N-butyl-2,2,6,6-tetramethyl-4-piperidinamine, oxidised, hydrogenated, commercially available, for example, as Tinuvin NOR® 371 (from BASF); reaction products of N,N′-ethane-1,2-diylbis(1,3-propanediamine), cyclohexane, peroxidized 4-butylamino-2,2,6,6-tetramethylpiperidine, and 2,4,6-trichloro-1,3,5-triazine, commercially available as Flamestab NOR 116 (from BASF); and Hostavin NOW ex (from Clariant).

The carrier layer (2) may further comprise at least one UV-absorber, preferably selected form the group consisting of hydroxybenzophenones, hydroxybenzotriazoles, triazines, anilides, benzoates, cyanoacrylates, and phenylformamidines.

According to one or more embodiments, the carrier layer comprises 0.05-10 wt.-%, preferably 0.1-5 wt.-%, more preferably 0.25-2.5 wt.-%, even more preferably 0.25-1.5 wt.-%, based on the total weight of the carrier layer, of at least one UV-absorber, preferably selected from the group consisting of hydroxybenzophenones, hydroxybenzotriazoles, triazines, anilides, benzoates, cyanoacrylates, phenylformamidines.

Suitable UV-absorbers for use in the carrier layer are commercially available, for example, under the trade name of Tinuvin® (from BASF), such as Tinuvin® 213, 234, 320, 326-329, 350, 360, 571.

According to one or more embodiments, the carrier layer has a thickness of 0.3-2.0 mm, preferably 0.35-1.75 mm, more preferably 0.4-1.75 mm, even more preferably 0.45-1.65 mm, still more preferably 0.5-1.5 mm. The thickness of the carrier layer of the sealing element can be determined by using the measurement method as defined in DIN EN 1849-2 standard.

According to one or more embodiments, the carrier layer has a width of 10-1000 mm, preferably 20-750 mm, more preferably 30-500 mm, even more preferably 30-300 mm.

The terms “width” and “length” refer to the two perpendicular dimensions measured in the horizontal plane of the first and second major surfaces of a sheet-like element. Generally, the “width” of a sheet like element is the smaller of the horizontal dimensions of the sheet-like element. Consequently, the “width” of the carrier layer refers to the minor dimension measured in the horizontal plane of the carrier layer in a direction perpendicular to the length of the carrier layer.

According to one or more preferred embodiments, the sealing element is an adhesive tape, preferably having a width of 10-1000 mm, more preferably 20-750 mm, even more preferably 30-500 mm, still more preferably 30-300 mm.

Adhesive tapes of the present invention are especially suitable for use in the field of construction, for example for sealing of construction gaps in building facades or joints formed between adjacent membranes, for repairing of leaking roof structures, or for connection of building segments, such as wall structures and window components.

The sealing element comprises, in addition to the carrier layer (2), a pressure sensitive adhesive layer (3).

The term “pressure sensitive adhesive (PSA)” refers in the present disclosure to viscoelastic materials, which adhere immediately to almost any kind of substrates by application of light pressure, and which are permanently tacky. The tackiness of an adhesive layer can be measured, for example, as a loop tack.

The term “pressure sensitive adhesive layer” refers to an adhesive layer that has been obtained by using a pressure sensitive adhesive, i.e., by using a process comprising applying a pressure sensitive adhesive to a surface of a substrate, such to a surface of the carrier layer of the sealing element, to form a layer.

Furthermore, the term “pressure sensitive adhesive” refers to all types of pressure sensitive adhesives independently of the technique that is used for applying the adhesive to a surface a substrate to form an adhesive layer. Consequently, pressure sensitive adhesives that are applied as a dispersion, such as water- and solvent based adhesives, as a hot-melt, or as a “syrup”, and subsequently cured, for example by drying or cooling (“physical curing”), or by initiation of chemical reactions (“chemical curing”), for example by subjecting the adhesive layer to actinic radiation, are considered to be encompassed by the term “pressure sensitive adhesive”.

Preferably, the pressure sensitive adhesive layer has a loop tack adhesion to a glass plate measured at a temperature of 23° C. of at least 2.5 N/25 mm, preferably at least 5 N/25 mm, more preferably at least 10 N/25 mm. The loop tack adhesion can be measured using a “FINAT test method no. 9 (FTM 9) as defined in FINAT Technical Handbook, 9th edition, published in 2014.

Suitable pressure sensitive adhesives for obtaining the pressure sensitive adhesive layer include adhesives comprising one or more compounds selected from the group consisting of styrene block copolymers, amorphous polyolefins (APO), amorphous poly-alpha-olefins (APAO), vinyl ether polymers, acrylic polymers, polyurethanes, and rubbers such as, for example, styrene-butadiene rubber (SBR), ethylene propylene diene monomer (EPDM) rubber, butyl rubber, polyisoprene, polybutadiene, natural rubber, polychloroprene rubber, ethylene-propylene rubber (EPR), nitrile rubber, acrylic rubber, ethylene vinyl acetate (EVA) rubber, and silicone rubber.

In addition to the above-mentioned compounds, suitable pressure sensitive adhesives typically comprise one or more additional constituents including, for example, monomers, tackifying resins, plasticizers, waxes, and additives, such as UV- and heat stabilizers, UV-absorbers, optical brighteners, pigments, dyes, and desiccants.

According to one or more embodiments, the pressure sensitive adhesive of the pressure sensitive adhesive layer (3) is selected from the group consisting of synthetic rubber-, natural rubber-, and bitumen-based pressure sensitive adhesives, and acrylic pressure sensitive adhesives.

According to one or more embodiments, the pressure sensitive adhesive is a styrene copolymer-based adhesive comprising:
A) 15-75 wt.-%, preferably 25-65 wt.-%, more preferably 35-60 wt.-%, of at least one styrene block copolymer SC,
B) 2.5-85 wt.-%, preferably 5-75 wt.-%, more preferably 10-65 wt.-%, of at least one tackifying resin TR,
C) 0-35 wt.-%, preferably 2.5-25 wt.-%, more preferably 5-15 wt.-%, of at least one mineral filler MF,
D) 0-30 wt.-%, preferably 2.5-25 wt.-%, more preferably 5-15 wt.-%, of at least one plasticizer PL, all proportions being based on the total weight of the styrene copolymer-based adhesive.

Suitable styrene block copolymers for use as the at least one styrene block copolymer SC include, styrene block copolymers of the SXS type, in each of which S denotes a non-elastomer styrene (or polystyrene) block and X denotes an elastomeric α-olefin block, which may be polybutadiene, polyisoprene, polyisoprene-polybutadiene, completely or partially hydrogenated polyisoprene (poly ethylene-propylene), or completely or partially hydrogenated polybutadiene (poly ethylene-butylene). The elastomeric α-olefin block preferably has a glass transition temperature in the range from −55° C. to −35° C. The elastomeric α-olefin block may also be a chemically modified α-olefin block. Particularly suitable chemically modified α-olefin blocks include, for example, maleic acid-grafted α-olefin blocks and particularly maleic acid-grafted ethylene-butylene blocks.

According to one or more embodiments, the at least one styrene block copolymer SC is selected from the group consisting of styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers.

The term “tackifying resin” designates in the present disclosure resins that in general enhance the adhesion and/or tackiness of an adhesive composition. The term “tackiness” designates in the present disclosure the property of a substance of being sticky or adhesive by simple contact. The tackiness can be measured, for example, as a loop tack. Preferred tackifying resins are tackifying at a temperature of 25° C. or below.

Examples of suitable compounds to be used as the at least one tackifying resin TR include natural resins, synthetic resins and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” refers to compounds obtained from the controlled chemical reactions such as polyaddition or polycondensation between well-defined reactants that do not themselves have the characteristic of resins.

Monomers that may be polymerized to synthesize the synthetic resins may include aliphatic monomer, cycloaliphatic monomer, aromatic monomer, or mixtures thereof. Aliphatic monomers can include C₄, C₅, and C₆ paraffins, olefins, and conjugated diolefins.

Examples of aliphatic monomer or cycloaliphatic monomer include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1,3-hexadiene, 1,4-hexadiene, cyclopentadiene, dicyclopentadiene, and terpenes. Aromatic monomer can include C₈, C₉, and C₁₀ aromatic monomer. Examples of aromatic monomer include styrene, indene, derivatives of styrene, derivatives of indene, coumarone, and combinations thereof.

Particularly suitable synthetic resins include synthetic hydrocarbon resins made by polymerizing mixtures of unsaturated monomers that are obtained as by-products of cracking of natural gas liquids, gas oil, or petroleum naphthas. Synthetic hydrocarbon resins obtained from petroleum-based feedstocks are referred in the present disclosure as “hydrocarbon resins” or “petroleum hydrocarbon resins”. These include also pure monomer aromatic resins, which are made by polymerizing aromatic monomer feedstocks that have been purified to eliminate color causing contaminants and to precisely control the composition of the product. Hydrocarbon resins typically have a relatively low average molecular weight (Mₙ), such in the range of 250-5000 g/mol and a glass transition temperature, determined by dynamical mechanical analysis (DMA) as the peak of the measured loss modulus (G″) curve using an applied frequency of 1 Hz and a strain level of 0.1%, of above 0° C., preferably equal to or higher than 15° C., more preferably equal to or higher than 30° C.

Examples of suitable hydrocarbon resins include C₅ aliphatic hydrocarbon resins, mixed C₅/C₉ aliphatic/aromatic hydrocarbon resins, aromatic modified C₅ aliphatic hydrocarbon resins, cycloaliphatic hydrocarbon resins, mixed C₅ aliphatic/cycloaliphatic hydrocarbon resins, mixed C₉ aromatic/cycloaliphatic hydrocarbon resins, mixed C₅ aliphatic/cycloaliphatic/C₉ aromatic hydrocarbon resins, aromatic modified cycloaliphatic hydrocarbon resins, C₉ aromatic hydrocarbon resins, polyterpene resins, and copolymers and terpolymers of natural terpenes as well hydrogenated versions of the aforementioned hydrocarbon resins. The notations “C₅” and “C₉” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from Rain Carbon); and under the trade name of Kristalex®, Plastolyn®, Piccotex®, Piccolastic® and Endex® (all from Eastman Chemicals).

According to one or more embodiments, the at least one tackifying resin TR has:
a softening point measured by a Ring and Ball method according to DIN EN 1238 standard in the range of 65-200° C., preferably 75-175° C., more preferably 80-170° C. and/or
an average molecular weight (Mₙ) in the range of 150-5000 g/mol, preferably 250-3500 g/mol, more preferably 250-2500 g/mol and/or
a glass transition temperature (Tg) determined by dynamical mechanical analysis (DMA) as the peak of the measured loss modulus (G″) curve using an applied frequency of 1 Hz and a strain level of 0.1% of at or above 0° C., preferably at or above 15° C., more preferably at or above 25° C., even more preferably at or above 30° C., still more preferably at or above 35° C.

Suitable compounds to be used as the at least one plasticizer PL are liquid plasticizers. The term “liquid” is generally defined as a material that flows at normal room temperature, has a pour point of less than 20° C. and/or a kinematic viscosity at 25° C. of 50000 cSt or less.

According to one or more embodiments, the at least one plasticizer PL is selected from the group consisting of mineral oils, synthetic oils, vegetable oils, and at 25° C. liquid hydrocarbon resins.

Suitable at 25° C. liquid hydrocarbon resins for use as the plasticizer PL include at 25° C. liquid polybutenes and at 25° C. liquid polyisobutylenes (PIB). The term “at 25° C. liquid polybutene” designates in the present disclosure low molecular weight olefin oligomers comprising isobutylene and/or 1-butene and/or 2-butene. The ratio of the C₄-olefin isomers can vary by manufacturer and by grade. When the C₄-olefin is exclusively 1-butene, the material is referred to as “poly-n-butene” or “PNB”. The term “at 25° C. liquid polyisobutylene” designates in the present disclosure low molecular weight polyolefins and olefin oligomers of isobutylene, preferably containing at least 75%, more preferably at least 85% of repeat units derived from isobutylene. Particularly suitable at 25° C. liquid polybutenes and polyisobutylenes have a molecular weight (Mₙ) of not more than 10000 g/mol, preferably not more than 5000 g/mol, more preferably not more than 3500 g/mol, even more preferably not more than 3000 g/mol, still more preferably not more than 2500 g/mol.

Liquid polybutenes are commercially available, for example, under the trade name of Indopol® H- and L-series (from Ineos Oligomers), under the trade name of Infineum® C-series and Parapol® series (from Infineum), and under the trade name of PB-series (Daelim). Liquid polyisobutylenes (PIBs) are commercially available, for example, under the trade name of Glissopal® V-series (from BASF) and and under the trade name of Dynapak®-series (from Univar GmbH, Germany).

According to one or more embodiments, the at least one mineral filler MF is selected from the group consisting of sand, granite, calcium carbonate, clay, expanded clay, diatomaceous earth, pumice, mica, kaolin, talc, dolomite, xonotlite, perlite, vermiculite, wollastonite, barite, magnesium carbonate, calcium hydroxide, calcium aluminates, silica, fumed silica, fused silica, aerogels, glass beads, hollow glass spheres, ceramic spheres, bauxite, comminuted concrete, and zeolites.

The term “sand” refers in the present disclosure to mineral clastic sediments (clastic rocks) which are loose conglomerates (loose sediments) of round or angular small grains, which were detached from the original grain structure during the mechanical and chemical degradation and transported to their deposition point, said sediments having an SiO₂ content of greater than 50 wt.-%, in particular greater than 75 wt.-%, particularly preferably greater than 85 wt.-%. The term “calcium carbonate” as mineral filler refers in the present document to calcitic fillers produced from chalk, limestone, or marble by grinding and/or precipitation.

According to one or more embodiments, the at least one mineral filler MF is selected from the group consisting of calcium carbonate, clay, expanded clay, diatomaceous earth, pumice, mica, kaolin, talc, dolomite, xonotlite, perlite, vermiculite, wollastonite, barite, magnesium carbonate, calcium hydroxide, calcium aluminates, silica, fumed silica, and fused silica.

Preferably, the at least one mineral filler MF has a median particle size d₅₀ of not more than 150 μm, more preferably not more than 100 μm. According to one or more embodiments, the at least one solid filler F has a median particle size d₅₀ of 0.1-100 μm, preferably 0.15-50 μm, more preferably 0.15-25 μm, even more preferably 0.25-15 μm.

The term “particle size” refers in the present disclosure to the area-equivalent spherical diameter of a particle (Xₐᵣₑₐ). The term “median particle size d₅₀” refers to a particle size below which 50% of all particles by volume are smaller than the d₅₀ value. In analogy, the term doo particle size refers in the present disclosure to a particle size below which 90% of all particles by volume are smaller than the doo value and term “d₁₀ particle size” refers to a particle size below which 10% of all particles by volume are smaller than the d₁₀ value. A particle size distribution can be measured by laser diffraction according to the method as described in standard ISO 13320:2009 using a wet or dry dispersion method and for example, a Mastersizer 2000 device (trademark of Malvern Instruments Ltd, GB).

According to one or more further embodiments, the pressure sensitive adhesive is a natural rubber-based adhesive comprising:
A) 15-75 wt.-%, preferably 25-65 wt.-%, more preferably 35-60 wt.-%, of at least one natural rubber NR,
B) 2.5-85 wt.-%, preferably 5-75 wt.-%, more preferably 10-65 wt.-%, of the at least one tackifying resin TR,
C) 0-35 wt.-%, preferably 2.5-25 wt.-%, more preferably 5-15 wt.-%, of the at least one mineral filler MF, all proportions being based on the total weight of the natural rubber-based adhesive.

According to one or more further embodiments, the pressure sensitive adhesive is a butyl rubber-based pressure sensitive adhesive, preferably comprising 15-75 wt.-%, preferably 25-65 wt.-%, based on the total weight of the butyl rubber-based pressure sensitive adhesive, of butyl rubber.

According to one or more preferred embodiments, the butyl rubber-based pressure sensitive adhesive comprises:
A) 15-75 wt.-%, preferably 25-65 wt.-%, more preferably 35-60 wt.-%, of butyl rubber BR,
B) 1-65 wt.-%, preferably 2.5-55 wt.-%, more preferably 5-45 wt.-%, of the at least one tackifying resin TR,
C) 0-35 wt.-%, preferably 1-30 wt.-%, more preferably 2.5-25 wt.-%, of the at least one mineral filler MF, and
D) 0-30 wt.-%, preferably 1.5-25 wt.-%, more preferably 2.5-20 wt.-%, of the at least one plasticizer PL, all proportions being based on the total weight of the butyl rubber-based adhesive.

According to one or more further embodiments, the pressure sensitive adhesive is a bitumen-based adhesive comprising:
A) 15-90 wt.-%, preferably 25-85 wt.-%, more preferably 35-75 wt.-%, even more preferably 40-70 wt.-%, of bitumen B and
A′) 5-35 wt.-%, preferably 10-30 wt.-%, more preferably 15-30 wt.-%, even more preferably 20-30 wt.-%, of at least one modifying polymer MP,
B) 2.5-30 wt.-%, preferably 5-25 wt.-%, of the at least one tackifying resin TR and/or
C) 2.5-30 wt.-%, preferably 5-25 wt.-%, of the at least one mineral filler MF, and/or
D) 0.5-15 wt.-%, preferably 2.5-10 wt.-%, of the at least one plasticizer PL, all proportions being based on the total weight of the bitumen-based adhesive.

The term “bitumen” designates in the present disclosure blends of heavy hydrocarbons, having a solid consistency at room temperature, which are normally obtained as vacuum residue from refinery processes, which can be distillation (topping or vacuum) and conversion (thermal cracking and visbreaking) processes of suitable crude oils. Furthermore, the term “bitumen” also designates natural and synthetic bitumen as well as bituminous materials obtained from the extraction of tars and bituminous sands.

The bitumen B can comprise one of more different types of bitumen materials, such as penetration grade (distillation) bitumen, air-rectified (semi-blown) bitumen, and hard grade bitumen.

The term “penetration grade bitumen” refers here to bitumen obtained from fractional distillation of crude oil. A heavy fraction composed of high molecular weight hydrocarbons, also known as long residue, which is obtained after removal of gasoline, kerosene, and gas oil fractions, is first distilled in a vacuum distillation column to produce more gas oil, distillates, and a short residue. The short residue is then used as a feed stock for producing different grades of bitumen classified by their penetration index, typically defined by a PEN value, which is the distance in tenth millimeters (dmm) that a needle penetrates the bitumen under a standard test method. Penetration grade bitumen are characterized by penetration and softening point. The term “air-rectified bitumen” or “air-refined bitumen” refers in the present disclosure to a bitumen that has been subjected to mild oxidation with the goal of producing a bitumen that meets paving-grade bitumen specifications. The term “hard grade bitumen” refers in the present disclosure to bitumen produced using extended vacuum distillation with some air rectification from propane-precipitated bitumen. Hard bitumen typically has low penetration values and high softening-points.

According to one or more embodiments, the bitumen B comprises at least 75 wt.-%, preferably at least 85 wt.-%, more preferably at least 90 wt.-% of at least one penetration grade bitumen, preferably having a penetration value in the range of 30-300 dmm, more preferably 70-220 dmm, even more preferably 100-160 and/or a softening point determined by Ring and Ball measurement conducted according to DIN EN 1238 standard in the range of 30-100° C., more preferably 30-70° C., even more preferably 30-50° C.

Suitable compounds for use as the modifying polymer MP include, for example, polyolefins, such as atactic polypropylene (APP), amorphous polyolefins (APO), styrene block copolymers, and rubbers.

The term “amorphous polyolefin (APO)” refers in the present disclosure to polyolefins having a low crystallinity degree determined by a differential scanning calorimetry (DSC) measurement, such as in the range of 0.001-10 wt.-%, preferably 0.001-5 wt.-%. The crystallinity degree of a polymer can be determined by using the differential scanning calorimetry measurements conducted according to ISO 11357 standard to determine the heat of fusion, from which the degree of crystallinity is calculated. In particular, the term “amorphous polyolefin” designates poly-α-olefins lacking a crystalline melting point (Tm) as determined by differential scanning calorimetric (DSC) or equivalent technique.

Suitable amorphous polyolefins for use as the modifying polymer MP include, for example, amorphous propene rich copolymers of propylene and ethylene, amorphous propene rich copolymers of propylene and butene, amorphous propene rich copolymers of propylene and hexene, and amorphous propene rich terpolymers of propylene, ethylene, and butene. The term “propene rich” is understood to mean copolymers and terpolymers having a content of propene derived units of at least 50 wt.-%, preferably at least 65 wt.-%, more preferably at least 70 wt.-%, based on total weight of the copolymer/terpolymer.

Preferred styrene block copolymers for use as the modifying polymer MP include, for example, styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers, preferably having a linear, radial, diblock, triblock or a star structure.

Suitable rubbers for use as the modifying polymer MP include, for example, styrene-butadiene rubber (SBR), ethylene propylene diene monomer rubber (EPDM), polyisoprene, polybutadiene, natural rubber, polychloroprene rubber, ethylene-propylene rubber (EPR), nitrile rubbers, and acrylic rubbers.

According to one or more embodiments, the at least one modifying polymer MP is selected from the group consisting of atactic polypropylene (APP), amorphous polyolefins (APO), styrene-butadiene-styrene (SBS) block copolymer, styrene-isoprene-styrene (SIS) block copolymer, styrene-butadiene rubber (SBR), ethylene propylene diene monomer (EPDM) rubber, polyisoprene, polybutadiene, natural rubber, polychloroprene rubber, ethylene-propylene rubber (EPR), nitrile rubbers, and acrylic rubbers, preferably from the group consisting of atactic polypropylene (APP), amorphous polyolefins (APO), styrene-butadiene-styrene (SBS) block copolymer, styrene-isoprene-styrene (SIS) block copolymer, and styrene-butadiene rubber (SBR).

According to one or more preferred embodiments, the pressure sensitive adhesive of the pressure sensitive adhesive layer (3) is an acrylic pressure sensitive adhesive. The term “acrylic pressure sensitive adhesive” designates in the present disclosure pressure sensitive adhesives containing one or more acrylic polymers as the main polymer component.

The term “acrylic polymer” designates in the present disclosure homopolymers, copolymers and higher inter-polymers of an acrylic monomer with one or more further acrylic monomers and/or with one or more other ethylenically unsaturated monomers. The term “monomer” refers to a compound that chemically bonds to other molecules, including other monomers, to form a polymer. The term “acrylic monomer” refers to monomers having at least one (meth)acryloyl group in the molecule. The term “(meth)acryloyl” designates methacryloyl or acryloyl. Accordingly, the term “(meth)acrylic” designates methacrylic or acrylic. A (meth)acryloyl group is also known as (meth)acryl group.

The acrylic polymer(s) may further be present in the pressure sensitive adhesive as a physically or chemically crosslinked polymer or as part of a chemically crosslinked polymer network comprising other polymers than acrylic polymers or as part of an interpenetrating or semi-interpenetrating polymer network (IPN).

The term “interpenetrating polymer network” refers to a polymer network comprising two or more dissimilar polymers that are in network form, i.e., chemically, or physically crosslinked. In an IPN, the polymer chains are not chemically bonded, but they are physically entangled by permanent chain entanglements. In a semi-interpenetrating polymer network, the polymer network and a linear or branched polymer penetrate each other at the molecular level.

According to one or more embodiments, the acrylic pressure sensitive adhesive comprises at least 35 wt.-%, preferably at least 50 wt.-%, more preferably at least 65 wt.-%, even more preferably at least 75 wt.-%, of at least one acrylic polymer AP, based on the total weight of the acrylic pressure sensitive adhesive.

Examples of suitable acrylic monomers for use in the at least one acrylic polymer AP include, for example, (meth)acrylates, (meth)acrylic acid or derivatives thereof, for example, amides of (meth)acrylic acid or nitriles of (meth)acrylic acid, and (meth)acrylates with functional groups such as hydroxyl group-containing (meth)acrylates and alkyl (meth)acrylates.

According to one or more embodiments, the acrylic polymer AP has been obtained from a monomer mixture comprising at least 45 wt.-%, preferably at least 55 wt.-%, more preferably at least 65 wt.-%, even more preferably at least 75 wt.-%, still more preferably at least 85 wt.-%, based on the total weight of the monomer mixture, of at least one acrylic monomer AM of formula (I):

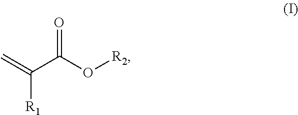

where
R₁ represents a hydrogen or a methyl group; and
R₂ represents a branched, unbranched, cyclic, acyclic, or saturated alkyl group having from 2 to 30 carbon atoms.

Examples of suitable acrylic monomers of formula (I) include methyl acrylate, methyl methacrylate, ethyl acrylate, ethoxy ethoxy ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, as for example isobutyl acrylate, 2-ethylhexyl acrylate, 2-ethylhexyl methacrylate, isooctyl acrylate, isooctyl methacrylate, and also cyclohexyl methacrylate, isobornyl acrylate, isobornyl methacrylate or 3,5-dimethyladamantyl acrylate.

Suitable comonomers to be used with the acrylic monomers of formula (I) include, for example, hydroxyl group containing acrylic monomers, such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl butyl (meth)acrylate, 2-hydroxy-hexyl(meth)acrylate, 6-hydroxy hexyl(meth)acrylate, 8-hydroxyoctyl(meth)acrylate, 10-hydroxydecyl(meth)acrylate, 12-hydroxylauryl (meth)acrylate. Further suitable hydroxyl group containing acrylic monomers include (4-hydroxymethyl cyclohexyl)methyl acrylate, polypropylene glycol mono (meth)acrylate, N-hydroxyethyl (meth) acrylamide, and N-hydroxypropyl (meth) acrylamide, esters of hydroxyethyl (meth)acrylate and phosphoric acid, and trimethoxysilylpropyl methacrylate.

According to one or more embodiments, the monomer mixture used for obtaining the at least one acrylic polymer AP comprises not more than 25 wt.-%, preferably not more than wt.-%, such as 0.01-15 wt.-%, preferably 0.1-10 wt.-%, based on the total weight of the monomer mixture, of at least one hydroxyl group containing acrylic monomer.

Further suitable comonomers for the synthesis of the at least one acrylic polymer AP include vinyl compounds, such as ethylenically unsaturated hydrocarbons with functional groups, vinyl esters, vinyl halides, vinylidene halides, nitriles of ethylenically unsaturated hydrocarbons, phosphoric acid esters, and zinc salts of (meth)acrylic acid. Examples of especially suitable vinyl compounds include, for example, maleic anhydride, styrene, styrenic compounds, acrylic acid, beta-acryloyloxypropionic acid, vinylacetic acid, fumaric acid, crotonic acid, aconitic acid, trichloroacrylic acid, itaconic acid, vinyl acetate, and acryloyl morpholine.

According to one or more embodiments, the monomer mixture used for obtaining the at least one acrylic polymer AP comprises at least 0.1 wt.-%, preferably at least 0.5 wt.-%, such as 0.1-20 wt.-%, preferably 0.5-15 wt. %, based on the total weight of the monomer mixture, of at least one vinyl compound, preferably selected from the group consisting of maleic anhydride, styrene, styrenic compounds, (meth) acrylamides, N-substituted (meth) acrylamides, acrylic acid, beta-acryloyloxypropionic acid, vinylacetic acid, fumaric acid, crotonic acid, aconitic acid, dimethylacrylic acid, trichloroacrylic acid, itaconic acid, vinyl acetate, and amino group-containing (meth) acrylates.

According to one or more embodiments, the pressure sensitive adhesive layer has been obtained by using a water- or solvent-based acrylic pressure sensitive adhesive composition, a hot-melt acrylic pressure sensitive adhesive composition or a syrup acrylic pressure sensitive adhesive composition.

The term “water-based pressure sensitive adhesive composition” designates in the present disclosure pressure sensitive adhesives, which have been formulated as an aqueous dispersion, an aqueous emulsion, or as an aqueous colloidal suspension. The term “aqueous dispersion” or “aqueous emulsion” refers to dispersions or emulsions containing water as the main continuous (carrier) phase. Typically, a water-based pressure sensitive adhesive composition comprises surfactants to stabilize the hydrophobic polymer particles and to prevent these from coagulating with each other.

The term “solvent-based pressure sensitive adhesive composition” designates in the present disclosure pressure sensitive adhesives comprising acrylic polymers, which are substantially completely dissolved in the organic solvent(s). Typically, the organic solvent(s) comprise at least 20 wt.-%, preferably at least 30 wt.-%, more preferably at least 40 wt.-%, of the total weight of the solvent-based pressure sensitive adhesive composition. The term “organic solvent” refers in the present document to organic substances that are liquid at a temperature of 25° C., are able to dissolve another substance at least partially, and have a standard boiling point of not more than 225° C., preferably not more than 200° C. The term “standard boiling point” refers in the present disclosure to boiling point measured at a pressure of 1 bar. The standard boiling point of a substance or composition can be determined, for example, by using an ebulliometer.

Suitable organic solvents for the solvent-based pressure sensitive adhesive composition include, for example, alcohols, aliphatic and aromatic hydrocarbons, ketones, esters, and mixtures thereof. It is possible to use only a single organic solvent or a mixture of two or more organic solvents. Suitable solvent-based pressure sensitive adhesive compositions are substantially water-free, for example, containing less than 10 wt.-%, preferably less than 5 wt.-%, more preferably less than 1 wt.-% of water, based on the total weight of the solvent-based pressure sensitive adhesive.

The term “hot-melt pressure sensitive adhesive composition” designates in the present disclosure solvent-free pressure sensitive adhesives, which are applied as a melt. The term “syrup pressure sensitive adhesive composition” refers to pressure sensitive adhesives having sufficiently low viscosity at normal room temperature due to the relative high proportion of monomers, which allows the application without heating of the adhesive.

According to one or more embodiments, the water- or solvent-based acrylic pressure sensitive adhesive composition comprises:
A1) 25-85 wt.-%, preferably 35-75 wt.-%, of the at least one acrylic polymer AP and
B1) 5-85 wt.-%, preferably 10-75 wt.-%, of water or at least one organic solvent, all proportions being based on the total weight of the water- or solvent-based acrylic pressure sensitive adhesive composition.

In addition to the at least one acrylic polymer AP, the water- or solvent-based acrylic pressure sensitive adhesive may further comprise one or more additional constituents including, for example, tackifying resins, waxes, and plasticizers as well as one or more additives, such as UV-light absorption agents, UV- and heat stabilizers, optical brighteners, pigments, dyes, and desiccants. Preferably, the total amount of such additional constituents and additives is not more than 35 wt.-%, more preferably not more than 25 wt.-%, most preferably not more than 15 wt.-%, based on the total weight of the water- or solvent-based acrylic pressure sensitive adhesive composition.

According to one or more embodiments, the pressure sensitive adhesive layer has been obtained by using an UV- or electron beam-curable acrylic pressure sensitive adhesive composition.

The term “UV-curable acrylic pressure sensitive adhesive composition” refers to acrylic pressure sensitive adhesives, which can be cured by initiation of photochemical curing reactions by UV-irradiation. The term “curing” in the present disclosure to chemical reactions comprising forming of bonds resulting, for example, in chain extension and/or crosslinking of polymer chains. The term “electron beam-curable acrylic pressure sensitive adhesive composition” refers in the present disclosure to acrylic pressure sensitive adhesives, which can be cured by initiation of curing reactions by electron beam irradiation.

According to one or more preferred embodiments, the pressure sensitive adhesive layer has been obtained by using an UV- or electron beam-curable acrylic hot-melt or syrup pressure sensitive adhesive composition, preferably of an UV-curable acrylic hot-melt or syrup pressure sensitive adhesive composition.

According to one or more embodiments, the UV-curable acrylic hot-melt pressure sensitive adhesive composition comprises:
A2) at least 65 wt.-%, preferably at least 75 wt.-%, of the at least acrylic polymer AP,
B2) 0-30 wt.-%, preferably 5-20 wt.-%, of the at least one tackifying resin TR,
C₂) 0-5 wt.-%, preferably 0.01-1 wt.-%, of at least one cross-linking agent CA,
D2) 0.1-5 wt.-%, preferably 0.25-2.5 wt.-%, of at least one photoinitiator PI,
all proportions being based on the total weight of the UV-curable acrylic hot-melt pressure sensitive adhesive composition.

The at least one cross-linking agent CA is preferably a multifunctional acrylate selected from the group consisting of butanediol di(meth)acrylate, ethyleneglycol di(meth)acrylate, diethyleneglycol di(meth)acrylate, triethyleneglycol di(meth)acrylate, trimethylolpropane trimethacrylate, hexanediol diacrylate, trimethylolpropane triacrylate, and tripropyleneglycol diacrylate, trimethylolpropane ethoxy triacrylate, trimethylolpropane triacrylate, tripropylene glycol diacrylate, propylene glycol di(meth)acrylate, dipropylene glycol diacrylate, dipentaerythritol hydroxy pentaacrylate, neopentyl glycol propoxylate diacrylate, bisphenol A ethoxylate di(meth)acrylate, alkoxylated hexanediol diacrylate, ethoxylated bisphenol A diacrylate, ethoxylated bisphenol A di(meth)acrylate, ethoxylated trimethylolpropane triacrylate, propoxylated neopentyl glycol diacrylate, propoxylated glyceryl triacrylate, and polybutadiene di(meth)acrylate.

Suitable compounds for use as the at least one photoinitiator PI include free radical photo initiators and cationic photo initiators, especially free radical photo initiators. Suitable compounds for use as photoinitiators include, for example, benzoic ethers, dialkoxyacetophenones, alpha-hydroxycyclohexyl aryl ketones, alpha-ketophenylacetate esters, benzyldialkylketals, chloro- and alkylthioxanthones and alpha-amino- and alpha-hydroxyalkyl aryl ketones.

Selection of the type of the at least one photoinitiator depends on the wavelength of the UV-radiation used for curing of the adhesive.

According to one or more embodiments, the at least one photoinitiator PI is a free radical photo initiator, which can be activated with UV-A irradiation, preferably with UVA-1 irradiation.

Preferred photoinitiators showing absorption in the UVA-1 irradiation wavelength range include so called Norrish type I initiators as well as some Norrish type II initiators.

Especially suitable Norrish type I photoinitiators include phospine oxides (PO), such as diphenyl(2,4,6-trimethylbenzoyl) phosphine oxide (TPO), ethyl phenyl(2,4,6-trimethylbenzoyl)phosphinate (TPO-L), phenylbis(2,4,6-trimethylbenzoyl) phosphine oxide (BAPO), bis-(2,6-dimethoxybenzoyl)-2,4,4-trimethylpentylphosphine oxide (BAPO-1), 2-benzyl-2-(dimethylamino)-4-morpholino-butyrophenone (BDMB), and phenyl-bis-(2,4,6-trimethylbenzoyl) phosphine oxide (BAPO-2). These are commercially available, for example, under the trade name of Omnirad (from IGM Resins), Genocure (from Rahn AG), Speedcure (from Lambson (part of Arkema), Songcure (from Songwon), and Photoinitiators from Bodo Möller Chemie.

Suitable Norrish type II photoinitiators include thiozanthones (TX), for example, 2-Isopropylthioxanthone (ITX), thioxanthone-anthracene (TX-A), 2,4-diethylthioxanthone (DETX), 2-Chlorothioxanthone (CTX), 2,4-Dimethylthioxanthone (RTX), 2,4-diisopropylthioxanthone (DITX), 1-Chloro-4-propoxythioxanthone (CPTX); polymeric TXs such as polymeric CPTX, polyTHF-di(thioxanthone-2-oxyacetate); and dl-camphorquinine 2,3-bornanedione (CQ). These are commercially available, for example, under the trade names of Genocure® (from Rahn GmbH), Omnirad® (from IGM resins), and SpeedCure® (from Lambson).

According to one or more embodiments, the at least one free radical photo initiator is a phosphine oxide based photoinitiator, preferably selected from the group consisting of diphenyl(2,4,6-trimethylbenzoyl) phosphine oxide (TPO), ethyl phenyl(2,4,6-trimethylbenzoyl)phosphinate (TPO-L), phenylbis(2,4,6-trimethylbenzoyl) phosphine oxide (BAPO), bis-(2,6-dimethoxybenzoyl)-2,4,4-trimethylpentylphosphine oxide (BAPO-1), and 2-benzyl-2-(dimethylamino)-4-morpholino-butyrophenone (BDMB).

Furthermore, the photoinitiators may be used in combination with synergists/activators that are well known to skilled person. The preferred type of the synergist depends on the type of the photoinitiator, for example the radical formation with Norrish type II initiators requires a hydrogen donor as a synergist. Examples of suitable synergists for the Norrish II initiators include, for example, amino benzoates, acrylated amines, and thiol compounds.

According to one or more further embodiments, the UV-curable acrylic hot-melt pressure sensitive adhesive composition comprises:
A3) At least 65 wt.-%, preferably at least 85 wt.-%, of at least one UV-curable acrylic polymer UV-AP having one or more photo initiator groups,
B3) 0-15 wt.-%, preferably 0.1-10 wt.-%, of at least one reactive diluent, and
C₃) 0-20 wt.-%, preferably 1-15 wt.-%, of the at least one mineral filler MF, all proportions being based on the total weight of the UV-curable acrylic hot-melt pressure sensitive adhesive composition.

The at least one UV-curable acrylic polymer UV-AP comprises polymerized units that serve as photoinitiators. Suitable polymerized units that serve as photo initiators may be obtained by using copolymerizable photo initiators, such as acetophenone and benzophenone derivatives.

According to one or more embodiments, the at least one UV-curable acrylic polymer UV-AP comprises 0.05-10 wt.-%, preferably 0.1-5 wt.-%, more preferably 0.1-1.5 wt.-%, based on the weight of the polymer UV-AP, of at least one ethylenically unsaturated compound having a photo initiator group.

Suitable UV-curable acrylic hot-melt pressure sensitive adhesives are commercially available, for example, under the trade name of acResin® (from BASF); under the trade name of AroCure® (form Ashland Chemical); and under the trade name of NovaMeltRC® (from Henkel).

According to one or more embodiments, the UV-curable acrylic syrup pressure sensitive adhesive composition comprises:
A4) at least 35 wt.-%, preferably at least 50 wt.-%, of the at least acrylic monomer AM,
B4) 0-30 wt.-%, preferably 5-20 wt.-%, of the at least one tackifying resin TR,
C₄) 0-5 wt.-%, preferably 0.01-1 wt.-%, of the at least one cross-linking agent CA, and
D4) 0.1-5 wt.-%, preferably 0.25-2.5 wt.-%, of the at least one photoinitiator PI, all proportions being based on the total weight of the UV-curable acrylic syrup pressure sensitive adhesive composition.

According to one or more further embodiments, the UV-curable acrylic syrup pressure sensitive adhesive composition comprises:
A51) at least 35 wt.-%, preferably at least 50 wt.-%, more preferably at least 55 wt.-%, even more preferably at least 65 wt.-%, of at least acrylic compound A,
A52) 1.5-55 wt.-%, preferably 2.5-45 wt.-%, more preferably 5-40 wt.-%, even more preferably 7.5-35 wt.-%, of a reaction product RP obtained by polyaddition reaction of at least one compound P with at least one hardener H,
B5) 0-30 wt.-%, preferably 5-20 wt.-%, of the at least one tackifying resin TR,
C₅) 0-5 wt.-%, preferably 0.01-1 wt.-%, of the at least one cross-linking agent CA, and
D6) 0.1-5 wt.-%, preferably 0.25-2.5 wt.-%, of the at least one photoinitiator PI, all proportions being based on the total weight of the UV-curable acrylic syrup pressure sensitive adhesive.

Examples of suitable acrylic compounds A for use in the UV-curable acrylic syrup pressure sensitive adhesive include acrylic monomers, such as (meth) acrylates, alkyl (meth) acrylates, di(meth) acrylates, and derivatives thereof, for example, amides and nitriles of (meth) acrylates. Further suitable acrylic compounds A include (meth)acryl-functional polymers, such as (meth)acrylate, polyurethane, polyether/polyoxyalkylene, and polyester polymers containing one or more (meth)acryl groups. The (meth)acryl groups of an (meth)acryl-functional polymer may be in pendant positions in the polymer chain or in terminal positions.

According to one or more embodiments, the at least one acrylic compound A contains exactly one acryl group.

Preferably, the at least one acrylic compound A has a weight average molecular weight (M_{w}) of not more than 25000 g/mol, more preferably not more than 15000 g/mol, even more preferably not more than 10000 g/mol.

According to one or more embodiments, the at least one acrylic compound A has a weight average molecular weight (M_{w}) in the range of 100-15000 g/mol, preferably 125-10000 g/mol, more preferably 125-7500 g/mol, even more preferably 125-5000 g/mol and/or a viscosity at 20° C. determined according to ISO 3219:1994 standard in the range of 250-25000 mPa·s, preferably 500-20000 mPa·s, more preferably 1000-15000 mPa·s, even more preferably 1500-15000 mPa·s.

As used in the present disclosure, the term “polyaddition reaction” refers to a reaction in which new bonds are formed by undergoing an addition reaction among functional groups of the compound having a functional group and the aforesaid reaction is successively repeated to form a polymer. Consequently, the at least one compound P contains first type of functional group(s) that that react with second type of functional group(s) contained in the at least one hardener H in the polyaddition reaction.

According to one or more embodiments, the at least one compound P contains isocyanate groups, i.e. the first type of functional groups of the at least one compound P are isocyanate groups and the at least one hardener contains isocyanate-reactive groups, i.e. the second type of functional groups of the at least one hardener H are isocyanate-reactive groups.

According to one or more embodiments, the polyaddition reaction between the at least one compound P and the at least one hardener H is conducted at a molar ratio of the isocyanate groups to the isocyanate-reactive groups of 0.95-1.5, preferably 0.97-1.2, more preferably 0.97-1.1, even more preferably 0.97-1.05.

The pressure sensitive adhesive layer has a thickness of at least 100 μm, preferably at least 150 μm, more preferably at least 200 μm, still more preferably at least 250 μm.

According to one or more preferred embodiments, the pressure sensitive adhesive layer has a thickness of 100-750 μm, preferably 125-650 μm, more preferably 150-500 μm, still more preferably 200-500 μm, even more preferably 250-500 μm.

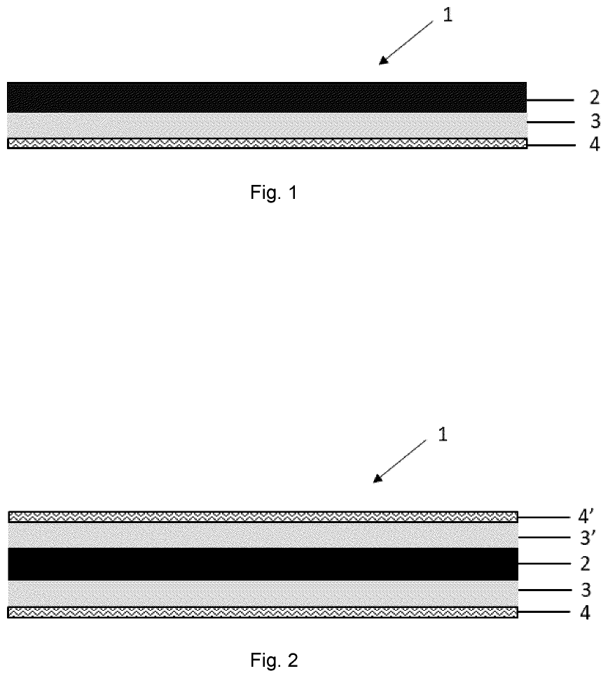

According to one or more embodiments, the sealing element (1) further comprises a release liner (4) covering at least a portion of an outer major surface of the pressure sensitive adhesive layer (3) facing away from the carrier layer (2), as shown in FIGS. 1-4.

The release liner is typically used to prevent premature unwanted adhesion and to protect the pressure sensitive adhesive layer from moisture, fouling, and other environmental factors. In case the sealing element is provided in form of rolls, the release liner enables ease of unwind without sticking of the adhesive to the back side of the sealing device. The release liner may be sliced into multiple sections to allow portioned detachment of the liner from the pressure sensitive adhesive layer.

Suitable materials for the release liner include Kraft paper, polyethylene coated paper, silicone coated paper as well as polymeric films, for example, polyethylene, polypropylene, and polyester films coated with polymeric release agents selected from silicone, silicone urea, urethanes, waxes, and long chain alkyl acrylate release agents.

The carrier layer and the pressure sensitive adhesive layer can be directly or indirectly connected to each other over at least a portion of their opposing major surfaces.

The expression “directly connected” is understood to mean in the context of the present invention that no further layer or substance is present between the two layers and that the opposing surfaces of the layers are directly bonded to each other or adhere to each other. The carrier layer and the pressure sensitive adhesive layer may be indirectly connected to each other though a middle layer, such as a migration barrier, a porous layer, for example a layer of non-woven fabric, or an adhesive sealant layer.

According to one or more embodiments, the carrier layer and the pressure sensitive adhesive layer are directly connected to each other over at least a portion of their opposing major surfaces, wherein the pressure sensitive adhesive layer covers at least 50%, preferably at least 75%, more preferably at least 85%, still more preferably at least 95%, most preferably at least 97.5%, of the area of the second major surface of the carrier layer. Exemplary sealing devices according to these embodiments are shown in FIGS. 1 and 2.

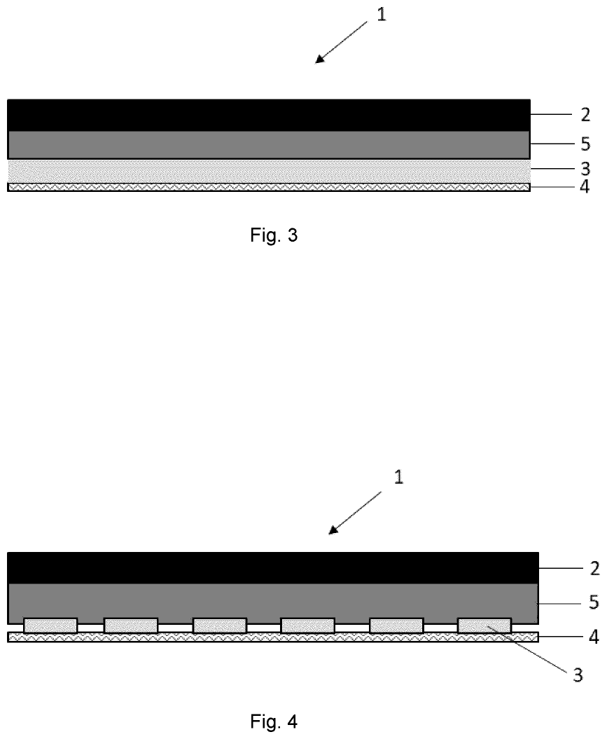

According to one or more further embodiments, the sealing element (1) further comprises an adhesive sealant layer (5) having first and second major surfaces arranged between the carrier layer (2) and the pressure sensitive adhesive layer (3). Exemplary sealing devices according to these embodiments are shown in FIGS. 3 and 4.

Preferably, the carrier layer and the adhesive sealant layer are directly connected to each other over at least a portion of their opposing major surfaces, wherein the adhesive sealant layer preferably covers at least 50%, preferably at least 75%, more preferably at least 85%, still more preferably at least 95%, most preferably at least 97.5%, of the area of the second major surface of the carrier layer.

According to one or more embodiments, the adhesive sealant layer and the pressure sensitive adhesive layer are directly connected to each other over at least a portion of their opposing major surfaces, wherein the pressure sensitive adhesive layer preferably covers at least 5%, preferably at least 10%, more preferably at least 15%, still more preferably at least 20%, most preferably at least 25%, of the area of the second major surface of the adhesive sealant layer.

According to one or more embodiments, the adhesive sealant layer and the pressure sensitive adhesive layer are directly connected to each other over at least a portion of their opposing major surfaces, wherein the pressure sensitive adhesive layer covers 25-85%, preferably 35-75%, even more preferably 35-65%, still more preferably 40-60%, of the area of the second major surface of the adhesive sealant layer.

According to one or more embodiments, the adhesive sealant layer has a thickness of at least 100 μm, preferably at least 200 μm, more preferably at least 300 μm, still more preferably at least 450 μm.

According to one or more preferred embodiments, the adhesive sealant layer has a thickness of 100-2000 μm, preferably 200-1500 μm, more preferably 250-1250 μm, still more preferably 300-1000 μm, even more preferably 350-1000 μm, most preferably 400-1000 μm.

Preferably, the adhesive sealant layer comprises:
a) At least one rubber R,
b) At least one at 25° C. liquid polyolefin resin PR, and
c) At least one inorganic filler IF.

According to one or more embodiments, the adhesive sealant layer comprises:
a) 1-40 wt.-%, preferably 5-40 wt.-%, more preferably 7.5-35 wt.-%, even more preferably 10-30 wt.-%, still more preferably 10-25 wt.-%, of the at least one rubber R,
b) 10-60 wt.-%, preferably 10-55 wt.-%, more preferably 15-55 wt.-%, even more preferably 20-50 wt.-%, still more preferably 25-45 wt.-%, of the at least one at 25° C. liquid polyolefin resin PR, and
c) 5-80 wt.-%, preferably 10-70 wt.-%, more preferably 15-60 wt.-%, even more preferably 20-60 wt.-%, still more preferably 25-55 wt.-%, of the at least one inorganic filler IF, all proportions being based on the total weight of the adhesive sealant layer.

According to one or more further embodiments, the at least one inorganic filler IF is present in the adhesive sealant layer in an amount of 25-80 wt.-%, preferably 30-75 wt.-%, more preferably 35-75 wt.-%, even more preferably 40-75 wt.-%, still more preferably 40-75 wt.-%, based on the total weight of the adhesive sealant layer.

According to one or more embodiments, the at least one rubber R is selected from the group consisting of ethylene-propylene rubber (EPR), butyl rubber, synthetic 1,4-cis-polyisoprene, polybutadiene, styrene-butadiene copolymer, isoprene-butadiene copolymer, styrene-isoprene-butadiene rubber, methyl methacrylate-butadiene copolymer, methyl methacrylate-isoprene copolymer, acrylonitrile-isoprene copolymer, and acrylonitrile-butadiene copolymer, preferably from the group consisting of ethylene-propylene rubber (EPR), butyl rubber, synthetic 1,4-cis-polyisoprene, polybutadiene, styrene-butadiene copolymer, isoprene-butadiene copolymer, and styrene-isoprene-butadiene rubber, more preferably from the group consisting of ethylene-propylene rubber (EPR), butyl rubber, synthetic 1,4-cis-polyisoprene, and polybutadiene.

It is furthermore preferred that the at least one rubber R is not chemically crosslinked or has a crosslinking degree of less than 2.5 wt.-%, preferably less than 1.5 wt.-%, more preferably less than 1 wt.-%, still more preferably less than 0.5 wt.-%, determined by using the method as defined in ISO 10147:2011 standard.

According to one or more embodiments, the at least one at 25° C. liquid polyolefin resin PR is selected from the group consisting of at 25° C. liquid polybutenes and at 25° C. liquid polyisobutylenes, preferably having a number average molecular weight (Mₙ) of not more than 5000 g/mol, more preferably not more than 3000 g/mol, even more preferably not more than 2500 g/mol and/or a polydispersity index (M_{w}/Mₙ), determined by GPC, of not more than 5, preferably in the range of 0.5-5.0, more preferably 1.0-4.5, even more preferably 1.0-3.5, still more preferably 1.25-3.0.

According to one or more embodiments, the at least one at 25° C. liquid polyolefin resin PR is at 25° C. liquid polybutene, preferably having a number average molecular weight (Mₙ) of not more than 5000 g/mol, more preferably not more than 2500 g/mol, even more preferably not more than 2000 g/mol, still more preferably not more than 1500 g/mol and/or a polydispersity index (M_{w}/Mₙ), determined by GPC, of not more than 5, preferably in the range of 0.5-5.0, more preferably 1.0-4.5, even more preferably 1.0-3.5, still more preferably 1.25-2.5.

According to one or more embodiments, the at least one at 25° C. liquid polyolefin resin PR is at 25° C. liquid polyisobutylene, preferably containing at least 75 wt.-%, more preferably at least 85 wt.-%, of repeat units derived from isobutylene, based on the weight of the at least one polyisobutylene, and preferably having a number average molecular weight (Mₙ) of not more than 5000 g/mol, more preferably not more than 3000 g/mol, even more preferably not more than 2750 g/mol and/or a polydispersity index (M_{w}/Mₙ), determined by GPC, of not more than 5, preferably in the range of 0.5-5.0, more preferably 1.0-4.5, even more preferably 1.0-3.5, still more preferably 1.25-2.5.

Preferably, the at least one inorganic filler IF is selected from the group consisting of sand, granite, calcium carbonate, clay, expanded clay, diatomaceous earth, pumice, mica, kaolin, talc, dolomite, xonotlite, perlite, vermiculite, wollastonite, barite, magnesium carbonate, calcium hydroxide, calcium aluminates, silica, fumed silica, fused silica, aerogels, glass beads, hollow glass spheres, ceramic spheres, bauxite, comminuted concrete, and zeolites.

According to one or more embodiments, the adhesive sealant layer further comprises at least on tackifying resin TR.

It may be preferable that the at least one tackifying resin TR is present in the adhesive sealant layer in an amount of not more than 40 wt.-%, more preferably not more than 30 wt.-%, based on the total weight of the adhesive sealant layer. According to one or more embodiments, the at least one tackifying resin TR is present in the adhesive sealant layer in an amount of 0.5-30 wt.-%, preferably 1-25 wt.-%, more preferably 1.5-22.5 wt.-%, even more preferably 2.5-20 wt.-%, still more preferably 2.5-15 wt.-%, such as 1-10 wt.-%, based on the total weight of the adhesive sealant layer.

The adhesive sealant layer may further comprise one or more additives, such as UV absorbers, UV stabilizers, heat stabilizers, antioxidants, flame retardants, optical brighteners, pigments, dyes, and biocides. The additives, if used at all, preferably comprise not more than 25 wt.-%, more preferably not more than 15 wt.-%, even more preferably not more than 10 wt.-%, most preferably not more than 5 wt.-%, of the total weight of the adhesive sealant layer.

The pressure sensitive adhesive layer covering the second major surface of the adhesive sealant layer can be a in form of a continuous or discontinuous adhesive layer.

The term “continuous adhesive layer” is understood to mean that the adhesive layer is composed of one single area on a surface coated with the adhesive. In contrast, the term “discontinuous adhesive layer” is understood to mean that the adhesive layer has a pattern composed of adhesive coated areas and adhesive free areas (voids). In case of a discontinuous adhesive layer, the term “thickness of the adhesive layer” is understood to mean the arithmetic average of the thicknesses of the adhesive coated areas.

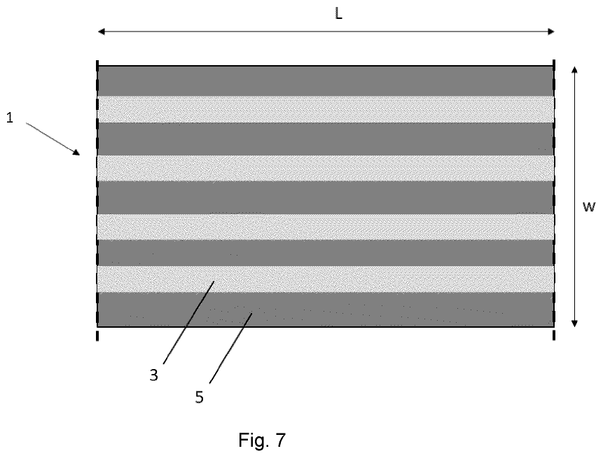

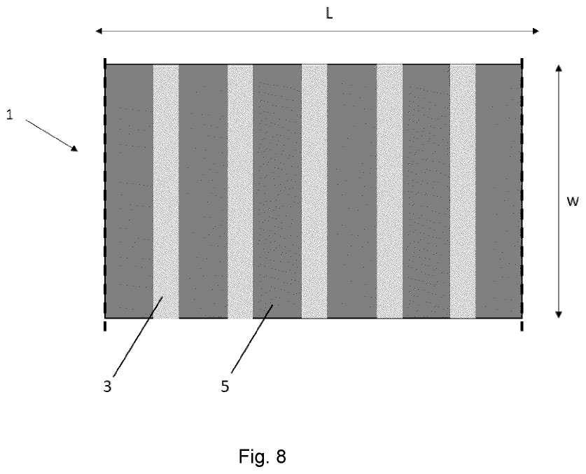

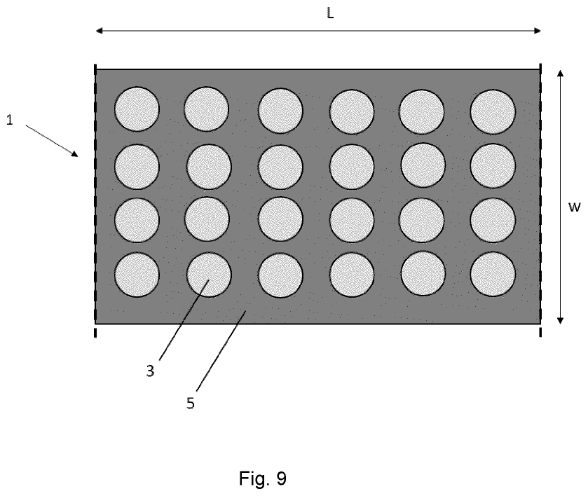

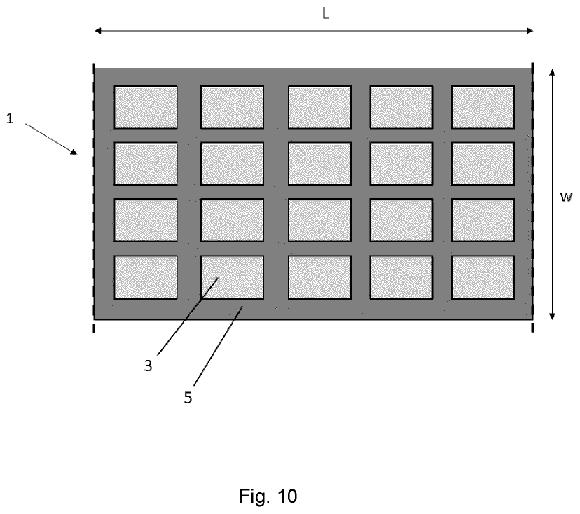

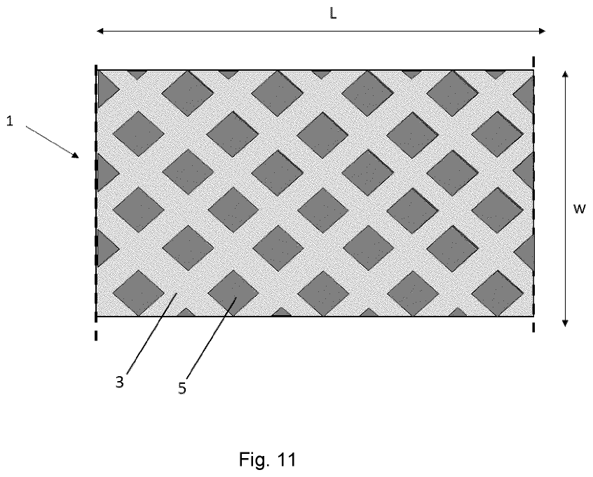

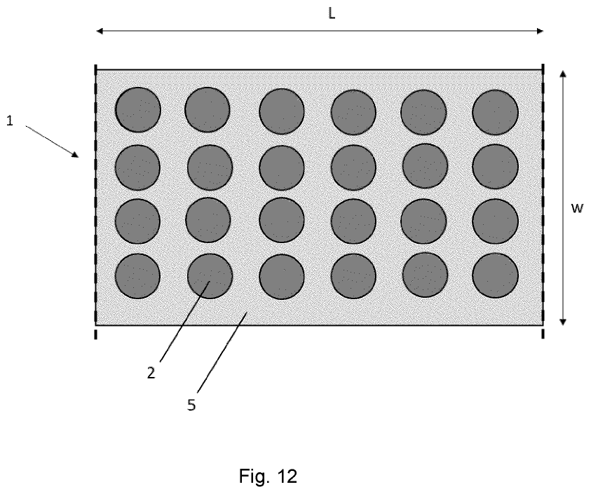

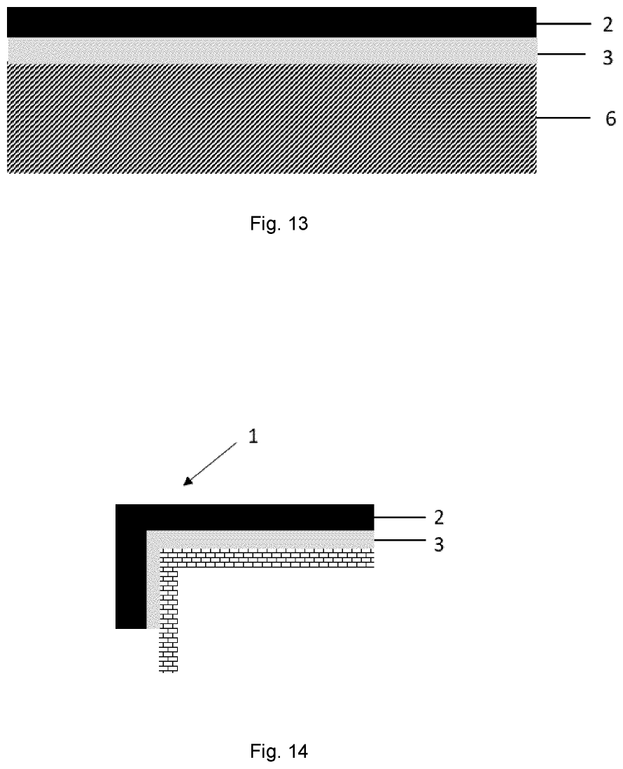

The pattern of the pressure sensitive adhesive layer can be composed of a discontinuous network of adhesive coated areas and discontinuous network of adhesive free areas as shown in FIGS. 7 and 8, or of a discontinuous network of adhesive coated areas and a continuous network of adhesive free areas, as shown in FIGS. 9 and 10, or of a continuous network of adhesive coated areas and a discontinuous network of adhesive free areas, as shown in FIGS. 11 and 12.

According to one or more preferred embodiments, the pressure sensitive adhesive layer has a pattern comprising a plurality of spaced-apart adhesive coated areas. The expression “spaced-apart” is understood to mean that adjacent adhesive coated areas are isolated from each other by an adhesive free area.

The spaced-apart adhesive coated areas can have any conventional shape, for example, circular, square, hexagonal, rectangular, polygonal, parallelogram, rhomboidal, or oval shape. Preferably, the minimum distance between two adjacent spaced-apart adhesive coated areas, before the pressure sensitive adhesive layer has been contacted with a surface of a substrate, is not less than 0.5 mm, more preferably not less than 1.5 mm, even more preferably not less than 2.5 mm.

According to one or more embodiments, the spaced-apart adhesive coated areas are in form of continuous stripes extending in the longitudinal (L), transverse (W), or diagonal direction of the sealing element. The term “in diagonal direction” is understood to mean a direction having an angle between the longitudinal (L) and transverse (W) directions of the sealing element. The expression “continuous adhesive stripe” is understood to mean that each adhesive stripe extends uninterrupted from one peripheral edge to the other opposite peripheral edge of the adhesive sealant layer. Exemplary sealing elements according to these embodiments are presented in FIGS. 7 and 8. The continuous adhesive stripes are preferably separated from each other by a distance of at least 5%, preferably at least 15%, more preferably at least 25%, of the width of each adhesive stripe.

The width of the continuous adhesive stripes is not particularly restricted, and the width may also vary along the length of the stripes. It is also possible that some adhesive stripes have a smaller or greater width than the other adhesive stripes. For example, it may be advantageous that in case of continuous longitudinally extending adhesive stripes, the adhesive stripes that are closer to the longitudinal edges of the adhesive sealant layer have a smaller width than the adhesive stripes near the center of the adhesive sealant layer, or vice versa. In case of continuous adhesive stripes extending in a transverse direction, the adhesive stripes preferably have the same width. According to one or more embodiments, each continuous adhesive stripe has a width corresponding to 2.5-25%, preferably 5-15% of the width of the adhesive sealant layer.

According to one or more further embodiments, the spaced-apart adhesive coated areas are in form of dots, preferably having a circular, square, hexagonal, rectangular, polygonal, parallelogram, rhomboidal, or oval shape, more preferably a circular, square, or rectangular shape. Exemplary sealing elements according to these embodiments are presented in FIGS. 9 and 10.

The dots can be uniformly distributed, or their density can become reduced or increased in the longitudinal (L) and/or transverse (W) direction of the sealing element. Preferably, the dots are uniformly distributed. Furthermore, the dots can be configured such that they line up in rows or such that they are offset between rows.

The dots can have substantially same size, or their size can become reduced or increased in the longitudinal or transverse direction of the sealing element. By “substantially same size” is meant here that the percentage difference between sizes of any dots is not more than 35%, preferably, more preferably not more than 25%, even more preferably not more than 15%, most preferably not more than 5%.

Preferably, the dots have a size of at least 25 mm2, more preferably at least 50 mm2, even more preferably at least 100 mm2. According to one or more further embodiments, the spaced-apart adhesive coated areas in form of dots have a size of 50-10000 mm2, more preferably 100-5000 mm2, even more preferably 150-3500 mm2, still more preferably 250-2500 mm2. The term “size a dot” refers here to the size of the area on the second major surface of the adhesive sealant layer covered by an individual dot. According to one or more embodiments, the average size of the dots is in the range of 100-7500 mm2, more preferably 150-5000 mm2, even more preferably 250-2500 mm2, still more preferably 350-1500 mm2. The term “average size” designates the arithmetic average of the sizes.

According to one or more further embodiments, the pressure sensitive adhesive layer has a pattern comprising an adhesive coated area and a plurality of spaced-apart adhesive free areas. Exemplary sealing elements according to these embodiments are presented in FIGS. 11 and 12.

The spaced-apart adhesive free areas can have any conventional shape, for example, circular, square, hexagonal, rectangular, polygonal, parallelogram, rhomboidal, or oval shape. Preferably, the minimum distance between two adjacent spaced-apart adhesive free areas, before the pressure sensitive adhesive layer has been contacted with a surface of a substrate, is not less than 0.5 mm, more preferably not less than 1.5 mm, even more preferably not less than 2.5 mm.

The spaced-apart adhesive free areas can be uniformly distributed, or their density can become reduced or increased in the longitudinal and/or transverse direction of the sealing element. Preferably, the spaced-apart adhesive free areas are uniformly distributed. Furthermore, the spaced-apart adhesive free areas can be configured such that they line up in rows or such that they are offset between rows.

The spaced-apart adhesive free areas can have substantially same size, or their size can become reduced or increased in the longitudinal or transverse direction of the sealing element. By “substantially same size” is meant here that the percentage difference between sizes of any spaced-apart adhesive free areas is not more than 35%, preferably, more preferably not more than 25%, even more preferably not more than 15%, most preferably not more than 5%.

Preferably, the spaced-apart adhesive free areas have a size of at least 25 mm2, more preferably at least 50 mm2, even more preferably at least 100 mm2. According to one or more further embodiments, the spaced-apart adhesive free areas have a size of 50-10000 mm2, more preferably 100-5000 mm2, even more preferably 150-3500 mm2, still more preferably 250-2500 mm2. According to one or more embodiments, the average size of the spaced-apart adhesive free areas is in the range of 100-7500 mm2, more preferably 150-5000 mm2, even more preferably 250-2500 mm2, still more preferably 350-1500 mm2. The term “average size” designates the arithmetic average of the sizes.

According to one or more embodiments, the pressure sensitive adhesive layer is partially embedded into to the adhesive sealant layer. The term “partially embedded” is understood to mean that the plane of the outer major surface of the pressure sensitive adhesive layer coincides with or lies above the plane of the second major surface of the adhesive sealant layer. According to one or more embodiments, not more than 25%, preferably not more than 20%, more preferably not more than 15%, even more preferably not more than 5%, of the thickness of the pressure sensitive adhesive layer extends beyond the plane of the second major surface of the adhesive sealant layer.

According to one or more embodiments, the sealing element comprises a further pressure sensitive adhesive layer (3′) and optionally a further release liner (4′) covering at least a portion of an outer major surface of the further pressure sensitive adhesive layer (3′) facing away from the carrier layer (2).

The carrier layer and the further pressure sensitive adhesive layer can be directly or indirectly connected to each other over at least a portion of their opposing major surfaces.

According to one or more embodiments, the carrier layer and the further pressure sensitive adhesive layer are directly connected to each other over at least a portion of their opposing major surfaces, wherein the further pressure sensitive adhesive layer covers at least 50%, preferably at least 75%, more preferably at least 85%, still more preferably at least 95%, most preferably at least 97.5%, of the area of the first major surface of the carrier layer.

According to one or more further embodiments, the sealing element (1) comprises a further adhesive sealant layer (5′) having first and second major surfaces arranged between the carrier layer (2) and the further pressure sensitive adhesive layer (3′).

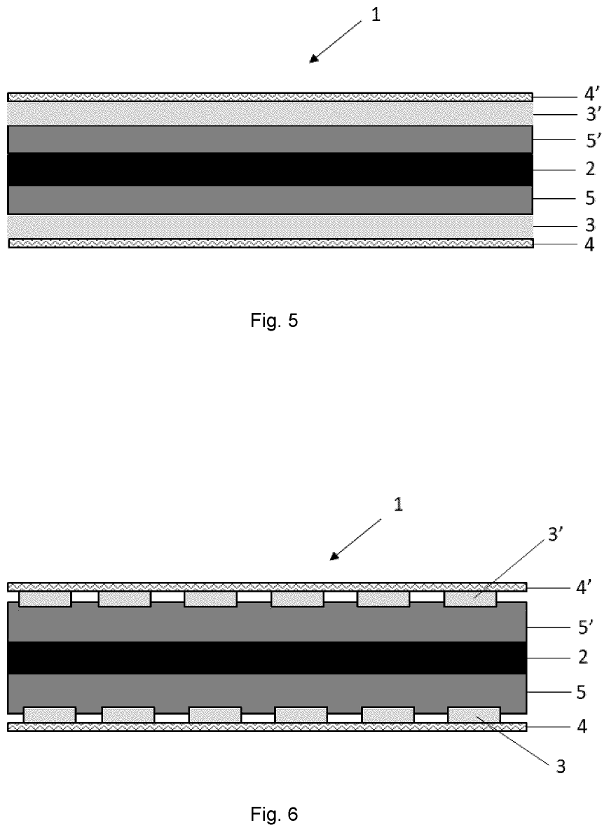

Preferably, the carrier layer and the further adhesive sealant layer are directly connected to each other over at least a portion of their opposing major surfaces, wherein the further adhesive sealant layer preferably covers at least 50%, preferably at least 75%, more preferably at least 85%, still more preferably at least 95%, most preferably at least 97.5%, of the area of the first major surface of the carrier layer. Exemplary sealing devices according to these embodiments are shown in FIGS. 5 and 6.

According to one or more embodiments, the further adhesive sealant layer and the further pressure sensitive adhesive layer are directly connected to each other over at least a portion of their opposing major surfaces, wherein the further pressure sensitive adhesive layer preferably covers at least 5%, preferably at least 10%, more preferably at least 15%, still more preferably at least 20%, most preferably at least 25%, of the area of the first major surface of the further adhesive sealant layer.

According to one or more embodiments, the further pressure sensitive adhesive layer covers 25-85%, preferably 35-75%, even more preferably 35-65%, still more preferably 40-60%, of the area of the first major surface of the further adhesive sealant layer.

The preferences given above for the pressure sensitive adhesive layer (3), the release liner (4), and the adhesive sealant layer (5) apply equally to the further pressure sensitive adhesive layer (3′), the further release liner (4′), and the further adhesive sealant layer (5′).

Furthermore, the preferences given above for the carrier layer (2), pressure sensitive adhesive layer (3), further pressure sensitive adhesive layer (3′), release liner (4), further release liner (4′), adhesive sealant layer (5), and to the further adhesive sealant layer (5′), apply equally to all aspects of the present invention unless otherwise stated.

Another subject of the present invention is a method for producing a sealing element, the method comprising steps of:
I) Providing a carrier layer (2) having a first and a second major surface,
IIa) Providing a pressure sensitive adhesive layer (3) on one of the major surfaces of the carrier layer (2) or
IIb) Providing an adhesive sealant layer (5) on one of the major surfaces of the carrier layer (2) and providing a pressure sensitive adhesive layer (3) on an outer major surface of the adhesive sealant layer (5) facing away from the carrier layer (2), and
III) Optionally covering an outer major surface of the pressure sensitive adhesive layer (3) facing away from the carrier layer (2) with a release liner (4).

The further details of the method for producing the sealing element depend on the embodiment of the sealing element, particularly on the type of the pressure sensitive adhesive.

In case a water- or solvent-based pressure sensitive adhesive composition is used for providing the pressure sensitive adhesive layer (3), step IIa) or IIb) of the method can comprise:
applying the water- or solvent-based pressure sensitive adhesive composition as a wet adhesive film to one of the major surfaces of the carrier layer (2) or on an outer major surface of the adhesive sealant layer (5) facing away from the carrier layer (2) and
drying the wet adhesive film by allowing the volatile components to evaporate, or
applying the water- or solvent-based pressure sensitive adhesive composition as a wet adhesive film to a surface of transfer sheet,
at least partially drying the wet adhesive film by allowing at least a portion of the volatile components to evaporate, and
transferring the at least partially dried adhesive film to one of the major surfaces of the carrier layer (2) or to an outer major surface of the adhesive sealant layer (5) facing away from the carrier layer (2).

In case a hot-melt pressure sensitive adhesive composition is used for providing the pressure sensitive adhesive layer (3), step IIa) or IIb) of the method can comprise:
heating the hot-melt pressure sensitive adhesive composition to allow the composition to flow and
applying the heated hot-melt pressure sensitive adhesive composition as an adhesive film to one of the major surfaces of the carrier layer (2) or on an outer major surface of the adhesive sealant layer (5) facing away from the carrier layer (2)
or
heating the hot-melt pressure sensitive adhesive composition to allow the composition to flow,
applying the heated hot-melt pressure sensitive adhesive composition as an adhesive film to a surface of transfer sheet, and
transferring the adhesive film to one of the major surfaces of the carrier layer (2) or to an outer major surface of the adhesive sealant layer (5) facing away from the carrier layer (2).

It may be preferred that the hot-melt acrylic pressure sensitive adhesive composition is heated to a temperature in the range of 60-250° C., such as 70-225° C., particularly 80-200° C.

In case a UV- or electron beam-curable pressure sensitive adhesive composition is used for providing the pressure sensitive adhesive layer (3), step IIa) or IIb) of the method can comprise:
applying the UV- or electron beam-curable pressure sensitive adhesive composition as an adhesive film to one of the major surfaces of the carrier layer (2) or on an outer major surface of the adhesive sealant layer (5) facing away from the carrier layer (2) and
at least partially curing the adhesive film by subjecting the adhesive film to UV- or electron beam radiation, or
applying the UV- or electron beam-curable pressure sensitive adhesive composition as an adhesive film to a surface of transfer sheet,
at least partially curing the adhesive film by subjecting the adhesive film to UV- or electron beam radiation, and
transferring the at least partially cured adhesive film to one of the major surfaces of the carrier layer (2) or to an outer major surface of the adhesive sealant layer (5) facing away from the carrier layer (2).

An adhesive composition may be applied to a surface of the carrier layer (2) or to a surface of the adhesive sealant layer (5) or to a surface of a transfer sheet by using any conventional techniques such as slot die coating, extrusion coating, roller coating, direct gravure coating, offset gravure coating, reverse gravure roll-coating, powder dispersion, or spray lamination techniques.

According to one or more embodiments, the method for producing a sealing element comprises a further step IV) of winding the composite element obtained in step II) or III) into a roll.

Another subject of the present invention is a method for bonding of a sealing element (1) to a substrate (6), the method comprising steps of:
I. Providing a sealing element (1) according to the present invention,
II. Applying the sealing element (1) onto a surface of the substrate (6) such that at least a portion of the outer major surface of the pressure sensitive adhesive layer (3) is directly connected to the surface of the substrate (6), and
III. Pressing the sealing element (1) against the surface of the substrate (6) with a pressure sufficient to affect adhesive bonding between the carrier layer (2) and the surface of the substrate (6).

The sealing element is typically provided in form of a roll and cut to a suitable length before being applied onto the surface of the substrate. In case the sealing element comprises a release liner, it is removed before the sealing element is applied onto the surface of the substrate.

It may be preferred that the surface of the substrate is pre-treated by chemical and/or physical cleaning methods, such as de-greasing or brushing and/or by the application of an adhesion promoter, an adhesion promoter solution or a primer, before the application of the sealing device. In general, it is not necessary to pre-treat the surface of the substrate by the application of an adhesion promoter, an adhesion promoter solution or a primer.

To secure sufficient bonding of the carrier layer (2) onto the surface of the substrate (6), the sealing element (1) is pressed against the surface of the substrate (6), for example, by using a roller or a scraper.

According to one or more embodiments, the substrate is a concrete, fiber concrete, metal, metal alloy, glass, thermoplastic polymer, rubber, wood, or plywood substrate.

Still another subject of the present invention is a sealed structure obtained by using the method for bonding of a sealing element (1) to a substrate (6).

The sealed structure comprises a sealing element (1) according to the present invention, wherein at least a portion of the second major surface of the carrier layer (2) is bonded to the surface of the substrate (6) via the pressure sensitive adhesive layer (3).

According to one or more embodiments, the substrate is a concrete, fiber concrete, metal, metal alloy, glass, thermoplastic polymer, rubber, wood, or plywood substrate.

### EXAMPLES

### Preparation of Test Specimens

All exemplary and reference sealing elements had the following basic buildup:
i) A polymeric carrier layer and
ii) A pressure sensitive adhesive layer.

The sealing elements were prepared by applying the pressure sensitive adhesive layer to a surface of the carrier layer. The thus obtained sealing elements were then tested for their adhesive bonding properties.

The following carrier layers were used for preparing the sealing devices. Carrier layers 2 and 4 were produced by extruding the melt-processed compositions of the carrier with a laboratory extruder.

Carrier 1: Upper layer of Sarnafil® AT 15, thickness 0.68 mm (from Sika Schweiz AG)

Carrier 2: Firestone Rubbergard®, EPDM, thickness 1.45 mm (from Firestone Building Products)

Carrier 3: 100% Milastomer®, TPV, thickness 1.6 mm

Carrier 4: Sarnafil® AT 15, thickness 1.5 mm (from Sika Schweiz AG)

Carrier 5: Sarnafil® TS 77 15, TPO membrane, thickness 1.5 mm (from Sika Schweiz AG)

Carrier 6: Sarnafil® AT 20, thickness 2.0 mm (from Sika Schweiz AG)

Carrier 7: Sarnafil® TS 77 20, TPO membrane, thickness 2.0 mm (from Sika Schweiz AG)

The following acrylic pressure sensitive adhesives provided on transfer tapes were used for preparing the pressure sensitive adhesive layers of the sealing elements:

Adhesive A: TransLINK® 130 RX-TC1646 (from Biolink) Adhesive B: DuploCOLL® 22522 (from Lohmann GmbH & Co. KG) Adhesive C: S-4615 AC PO80 (from ATP adhesive systems AG)

The structure of the tested sealing elements and the measured adhesive bonding properties (holding time) are shown in Table 1.

### Holding Time

A sample strip having dimensions of 4×2 cm was cut from the sealing element and adhered to an outer surface of a L-shaped electrogalvanized steel bar via the pressure sensitive adhesive layer. The sample strip was folded and contacted to both sides of the L-shaped bar over the whole area of the pressure sensitive adhesive layer such that approximately ⅔ of the length (“long portion”) of the sample strip was contacted with the horizontal portion of the steel bar whereas the remaining portion (“short portion”) of the sample strip was contacted with the vertical portion of the steel bar as shown in FIG. 14. The folded parts of the sample strip were pressed against the surface of the steel bar by rolling over twice back and forth using a roller with a weight of 5 kg to effect adhesive bonding between the sample strip and the steel bar.

The thus obtained test specimens were stored at standard room temperature (23° C.) and the time between bonding of the sample strips and delamination of the short portion of the sample strip from the surface of the steel bar was recorded as the “holding time”.

TABLE 1

| | | Carrier | | Adhesive | | |
|---|---|---|---|---|---|---|
| | | layer | | layer | | |
| | Carrier | thickness | Adhesive | thickness | Holding | |
| Example | type | [mm] | type | [μm] | time | |
| Ex-2.1 | 1 | 0.68 | A | 130 | >6 | d |
| Ex-2.2 | 1 | 0.68 | B | 220 | >6 | d |
| Ex-2.3 | 1 | 0.68 | C | 150 | >6 | d |
| Ex-3.1 | 2 | 1.50 | A | 130 | >6 | d |
| Ex-3.2 | 2 | 1.50 | B | 220 | >6 | d |
| Ex-3.3 | 2 | 1.50 | C | 150 | >6 | d |
| Ex-4.1 | 3 | 1.60 | A | 130 | >6 | d |
| Ex-4.2 | 3 | 1.60 | B | 220 | 3 h 56 min | |
| Ex-4.3 | 3 | 1.60 | C | 150 | >6 | d |
| Ex-5.1 | 4 | 1.50 | A | 130 | >6 | d |
| Ex-5.2 | 4 | 1.50 | B | 220 | 3 h 50 min | |
| Ex-5.3 | 4 | 1.50 | C | 150 | 2 h 21 min | |
| Ref Ex-1.1 | 5 | 1.50 | A | 130 | 4 h 13 min | |
| Ref Ex-1.2 | 5 | 1.50 | B | 220 | 59 | min |
| Ref Ex-1.3 | 5 | 1.50 | C | 150 | 25 | min |
| Ex-6.1 | 6 | 2.00 | A | 130 | 1 h 15 min | |
| Ex-6.2 | 6 | 2.00 | B | 220 | 4 h 36 min | |
| Ex-6.3 | 6 | 2.00 | C | 150 | 35 | min |
| Ref Ex-2.1 | 7 | 2.00 | A | 130 | 1 h 15 min | |
| Ref Ex-2.2 | 7 | 2.00 | B | 220 | 6 | min |
| Ref Ex-2.3 | 7 | 2.00 | C | 150 | 54 | sec |

1. A sealing element comprising:
i) a carrier layer having a first and a second major surface,
ii) a pressure sensitive adhesive layer having a thickness of at least 100 μm, and
iii) optionally a release liner covering at least a portion of an outer major surface of the pressure sensitive adhesive layer facing away from the carrier layer,
wherein the carrier layer comprises a polymer component comprising at least one elastomer E and/or at least one thermoplastic vulcanizate TPV and wherein the carrier layer has a thickness of at least 0.2 mm.

2. The sealing element according to claim 1, wherein the polymer component comprises at least 1.5 wt.-%, of the at least one elastomer E and/or the at least one thermoplastic vulcanizate TPV, based on the total weight of the polymer component.

3. The sealing element according to claim 1, wherein the polymer component further comprises at least one propylene copolymer PC.

4. The sealing element according to claim 3, wherein the polymer component comprises 5-85 wt.-%, of the at least one propylene copolymer PC, based on the total weight of the polymer component.

5. The sealing element according to claim 3, wherein, the at least one propylene copolymer PC is a propylene-ethylene copolymer.

6. The sealing element according to claim 1, wherein the at least one elastomer E comprises at least one butyl rubber E1 and/or at least one ethylene propylene diene monomer rubber E2.

7. The sealing element according to claim 1, wherein the at least one thermoplastic vulcanizate TPV comprises a blend of a thermoplastic resin and particles of a at least partially vulcanized rubber dispersed throughout a matrix of the thermoplastic resin.

8. The sealing element according to claim 1, wherein the carrier layer comprises at least 35 wt.-%, of the polymer component, based on the total weight of the carrier layer.

9. The sealing element (H) according to claim 1, wherein the carrier layer has a thickness of 0.3-2.0 mm, and/or a width of 10-1000 mm.

10. The sealing element according to claim 1, wherein the pressure sensitive adhesive of the pressure sensitive adhesive layer is selected from the group consisting of synthetic rubber-, natural rubber-, and bitumen-based pressure sensitive adhesives, and acrylic pressure sensitive adhesives.

11. The sealing element according to claim 1, wherein the pressure sensitive adhesive of the pressure sensitive adhesive layer is a butyl rubber-based pressure sensitive.

12. The sealing element according to claim 1, wherein the pressure sensitive adhesive of the pressure sensitive adhesive layer is an acrylic pressure sensitive adhesive.

13. The sealing element according to claim 12, wherein the acrylic polymer AP has been obtained from a monomer mixture comprising at least 45 wt.-%, based on the total weight of the monomer mixture, of at least one acrylic monomer AM of formula (I): 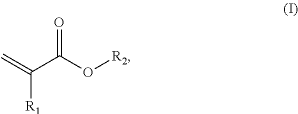
where
R₁ represents a hydrogen or a methyl group; and
R₂ represents a branched, unbranched, cyclic, acyclic, or saturated alkyl group having from 2 to 30 carbon atoms.

14. The sealing element according to claim 1, wherein the pressure sensitive adhesive layer has been obtained by using an UV- or electron beam-curable acrylic pressure sensitive adhesive.

15. The sealing element according to claim 1 further comprising an adhesive sealant layer having first and second major surfaces arranged between the carrier layer and pressure sensitive adhesive layer.

16. The sealing element according to claim 15, wherein the carrier layer and the adhesive sealant layer are directly connected to each other over at least a portion of their opposing major surfaces.

17. The sealing element according to claim 15, wherein the adhesive sealant layer and the pressure sensitive adhesive layer are directly connected to each other over at least a portion of their opposing major surfaces.

18. The sealing element according to claim 15, wherein the adhesive sealant layer comprises:
a) at least one rubber R,
b) at least one at 25° C. liquid polyolefin resin PR, and
c) at least one inorganic filler IF.

19. The sealing element according to claim 1, wherein the pressure sensitive adhesive layer has a pattern comprising a plurality spaced-apart adhesive coated areas or a pattern comprising an adhesive coated area and a plurality of spaced-apart adhesive free areas.

20. The sealing element according to claim 19, wherein the spaced-apart adhesive coated areas are in form of continuous stripes extending in the longitudinal, transverse, or diagonal direction of the sealing element or in form of dots.

21. A method for producing a sealing element according to claim 1, the method comprising steps of:
I) providing a carrier layer having a first and a second major surface,
IIa) providing a pressure sensitive adhesive layer on one of the major surfaces of the carrier layer or
IIb) providing an adhesive sealant layer on one of the major surfaces of the carrier layer and providing a pressure sensitive adhesive layer on an outer major surface of the adhesive sealant layer facing away from the carrier layer, and
III) optionally covering an outer major surface of the pressure sensitive adhesive layer facing away from the carrier layer with a release liner.

22. A method for bonding a sealing element to a substrate, the method comprising steps of:
I. providing a sealing element according to claim 1,
II. applying the sealing element onto a surface of the substrate such that at least a portion of the outer major surface of the pressure sensitive adhesive layer is directly connected to the surface of the substrate, and
III. pressing the sealing element against the surface of the substrate with a pressure sufficient to affect adhesive bonding between the carrier layer and the surface of the substrate.
